(19) United States
(12) Patent Application Publication
(10) Pub. No.: US 2025/0214617 A1
(43) Pub. Date: Jul. 3, 2025

(54) Autonomous Vehicle Motion Control for Pull-Over Maneuvers

(71) Applicant: Aurora Operations, Inc., Pittsburgh, CA (US)

(72) Inventors: Silia Gazepi, San Francisco, CA (US); Amit Hasmukh Patel, Mountain View, CA (US); Rohan Sameer Raval, San Francisco, CA (US)

(21) Appl. No.: 18/440,005

(22) Filed: Feb. 13, 2024

(30) Foreign Application Priority Data
Dec. 28, 2023 (GR) 20230101082

(51) Int. Cl. B60W 60/00

(52) U.S. Cl. CPC B60W 60/0011; B60W 60/0015; B60W 2520/06; B60W 2520/10; B60W 2552/53; B60W 2556/40; B60W 2556/45

(57) ABSTRACT

An example method includes (a) obtaining a pull-over command indicating the autonomous vehicle is to pull-over to a side of a travel way; (b) in response to the pull-over command, obtaining map data indicative of a plurality of pull-over locations for the autonomous vehicle; (c) determining one or more candidate pull-over locations for the autonomous vehicle based on the map data and a route of the autonomous vehicle; (d) determining a ranking of the candidate pull-over locations based on a feasibility of the autonomous vehicle completing a stop at each respective candidate pull-over location and a quality of each respective candidate pull-over location; (e) based on the ranking of the candidate pull-over locations, determining a selected pull-over location for the autonomous vehicle; and (f) controlling a motion of the autonomous vehicle based on the selected pull-over location.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

Example implementations of the present disclosure can improve the ability of an autonomous vehicle to pull-over onto the side of a travel way. To do so, the autonomous vehicle can analyze encoded map data to determine, for a given route, a plurality of candidate locations where the autonomous vehicle may pull-over onto a shoulder of the road. The autonomous vehicle can rank the candidate locations based on the feasibility of reaching the particular location and a quality of the location. The feasibility can represent a probability that the autonomous vehicle will practically be able to reach and pull-over at the location within a desired timeframe, given the vehicle's current speed, heading, lane position, etc. The quality can indicate, for example, the length and width of the candidate location. Using the ranking, the autonomous vehicle can select a pull-over location and plan its motion accordingly so that it stops at the selected location. In this way, the autonomous vehicle can more effectively and efficiently select, plan, and control its motion to pull-over to a side of a travel way, out of the lanes of traffic.

To provide a particular example, an autonomous vehicle may experience conditions such that it would be preferable for the autonomous vehicle to pull-over to the shoulder of the road. The conditions can include, for example, the presence of an emergency vehicle, potential inclement weather (e.g., a tornado warning), or an onboard condition. The conditions can be identified by the vehicle's onboard computing system or a teleassist system that is remote from the autonomous vehicle. The vehicle computing system (or the remote system) can provide an instruction for the autonomous vehicle to pull-over, which can include the vehicle performing a maneuver that positions the autonomous vehicle out of the lane boundaries onto the side/shoulder of the road.

The instruction may include a timeframe and/or distance for the autonomous vehicle to pull-over. The timeframe and distance can be proportional to the severity of the condition. For instance, the instructions may specify that the autonomous vehicle should pull-over within the next 5 minutes or within the next 8 km, given a tornado warning.

In response, the autonomous vehicle can determine where it may be able to pull-over. To do so, the autonomous vehicle can obtain map data. The map data can be a lightweight representation of a denser map of the geographic area in which the autonomous vehicle is/will be traveling. The map data can be labeled with a plurality of pull-over locations that are suitable for the autonomous vehicle. For instance, in the event the autonomous vehicle is an autonomous truck, the suitable pull-over locations may include areas within a shoulder that have the physical dimensions for the entire autonomous truck (and trailer) to stop outside the lanes of travel with at least a threshold margin (e.g., 0.5 m) from the closest lane boundary. For each of the pull-over locations, the map data can be encoded with descriptors associated with the respective pull-over location. This can include information such as the physical dimensions (e.g., length, width) of the area for stopping at the pull-over location, narrowing of the area (e.g., gradients in width), speed constraints (e.g., maximum approach speed), etc.

The autonomous vehicle can include a route planner that is configured to generate appended route data. For example, the route planner can access the encoded map data and data indicative of the vehicle's global route. The global route can be, for example, the nominal route the vehicle is currently, or will be, traveling to go from one city to another.

The route planner can filter the plurality of pull-over locations to disregard any pull-over locations that are unreachable by the autonomous vehicle. This can include, for example, filtering out pull-over locations that are completely behind the autonomous vehicle. Additionally, or alternatively, the route planner can identify pull-over locations that are along the global route such as those within a threshold distance from the global route.

The route planner can generate route data by appending the descriptors of the filtered pull-over locations to data indicative of the vehicle's global route. This can include all the pull-over locations along a route that are not completely behind the autonomous vehicle's location, including pull-over locations that are “split” by the autonomous vehicle. “Split” pull-over locations may be those that are partially in front of and partially behind the autonomous vehicle.

The autonomous vehicle can include a proposer system that is configured to identify candidate pull-over locations for the autonomous vehicle based on the route data. The proposer system can be included within a local router of the vehicle's motion planner. The proposer system can process the route data to determine which of the candidate pull-over locations are accessible to the autonomous vehicle along its global route.

To help determine pull-over candidates, the proposer system can determine the position of the autonomous vehicle relative to each of the pull-over locations encoded in the route data (or at least those within a threshold distance of the global route). The proposer system can further filter the plurality of pull-over locations of the route data. For example, the proposer system can filter out the portions of the “split” pull-over locations that are behind the autonomous vehicle (or otherwise unreachable).

The autonomous vehicle can include a ranker system that is configured to rank the candidate pull-over locations. The ranking can be based on a feasibility of the autonomous vehicle completing a stop at the respective pull-over locations. The feasibility can represent a probability of the autonomous vehicle being able to reach and stop at the pull-over location based on the vehicle's motion parameters (e.g., its speed, heading, lane) and the specified time for the autonomous vehicle to pull-over (e.g., within the next 5 minutes, 8 km).

The ranking can also be based on the quality of each respective candidate pull-over location. The quality of a respective candidate pull-over location can indicate the length and width of the candidate.

The ranking can be computed based on a cost function. In an example, for each candidate pull-over location, the ranker can evaluate the cost for the autonomous vehicle to travel to, and stop at, the pull-over location. The cost can be higher in the event that attempting to reach a nearby candidate pull-over location would include an undesirable level of jerk/lateral acceleration and/or the quality of the pull-over location is lower (e.g., the autonomous vehicle would barely fit or not fit within its dimensions). The candidate pull-over locations can be ranked based on their respective costs, from lowest to highest cost.

The autonomous vehicle's motion planner can be configured to plan the vehicle's motion such that it reaches and performs a pull-over maneuver at the pull-over location. For instance, the local router can be configured to select a pull-over location. For example, the local router can select the lowest cost candidate pull-over location. The local router can route the autonomous vehicle to the selected pull-over location by replacing the vehicle's global route with the route to the selected pull-over location (e.g., the “pull-over route”). The autonomous vehicle can travel along the pull-over route to arrive nearby the selected pull-over location.

The selected pull-over location can include a goal range. The goal range can define, for example, a rectangular area, on a shoulder of a travel way, in which the autonomous vehicle is to stop. The goal range for the selected pull-over location can be encoded within the route data that includes the pull-over route.

The motion planner can generate a trajectory for the autonomous vehicle to travel to a stopped position within the goal range associated with the selected pull-over location. The autonomous vehicle can control its motion based on the trajectory such that the autonomous vehicle reaches the stopped position within the goal range. By doing so, the autonomous vehicle can ensure that it is properly positioned on a shoulder of the travel way, with the threshold margins from the lane boundaries.

The technology of the present disclosure can provide a number of technical effects and benefits that improve the functioning of the autonomous vehicle and its computing systems. More particularly, the systems and methods described herein provide an improved approach for selecting a location for an autonomous vehicle to pull-over. For example, by filtering the pull-over locations upfront and costing the filtered locations based on feasibility/quality, the autonomous vehicle can avoid wasting computational resources to further analyze unneeded pull-over locations, while also avoiding unnecessary motion planning. This allows the autonomous vehicle to focus its downstream processing on a more relevant subset of pull-over opportunities. Additionally, the autonomous vehicle can save significant onboard computing resources (e.g., processing, memory, etc.) and allocate these resources to the vehicle's core autonomy functions. This leads to faster/more robust environmental perception and motion planning.

The technology of the present disclosure advantageously leverages various components of the vehicle's autonomy system. For example, the autonomous vehicle can leverage the more general analytical approach of the local router to help propose and rank the pull-over locations. The more precision-oriented components of the motion planner can then be used to travel to and accurately stop the autonomous vehicle at the selected pull-over location. In this way, the autonomous vehicle can implement the disclosed technology in a manner that leverages the computational expertise of its various modules, increasing the processing efficiency. Moreover, by leveraging the motion planner to develop granular trajectories for stopping within an appropriate goal range, the autonomous vehicle is able to more accurately position itself on the side of a travel way, outside the traffic lanes.

The technology of the present disclosure expands an autonomous vehicle's ability to find appropriate pull-over locations, without the constraints introduced by a local map. For example, the lighter weight map data encoding the pull-over locations can allow the autonomous vehicle to consider longer-range options beyond those within a local map, without introducing significant latency into the autonomy pipeline. As such, where timing permits, the autonomous vehicle is able to leverage its respective routing and motion planning functions to arrive at the pull-over location at a future point along the route, without having to activate urgent override motion planning protocols to reach a pull-over location identified in the local map.

For example, in an aspect, the present disclosure provides an example computer-implemented method. The example method includes (a) obtaining a pull-over command indicating an autonomous vehicle is to pull-over to a side of a travel way. The example method includes (b) in response to the pull-over command, obtaining map data indicative of a plurality of pull-over locations for the autonomous vehicle. The example method includes (c) determining, from among the plurality of pull-over locations, one or more candidate pull-over locations for the autonomous vehicle based on the map data and a route of the autonomous vehicle. The example method includes (d) determining a ranking of the one or more candidate pull-over locations based on (i) a feasibility of the autonomous vehicle completing a stop at each respective candidate pull-over location and (ii) a quality of each respective candidate pull-over location. The example method includes (e) based on the ranking of the one or more candidate pull-over locations, determining a selected pull-over location for the autonomous vehicle. The example method includes (f) controlling a motion of the autonomous vehicle based on the selected pull-over location.

In some implementations, the example method includes: (g) for the selected pull-over location, determining a respective goal range that defines an area associated with the selected pull-over location within which the autonomous vehicle is to stop.

In some implementations of the example method, (f) includes: generating a trajectory for the autonomous vehicle to travel to a stopped position within a goal range associated with the selected pull-over location; and controlling the motion of the autonomous vehicle based on the trajectory such that the autonomous vehicle reaches the stopped position within the goal range.

In some implementations of the example method, (d) includes: determining the ranking of the one or more candidate pull-over locations based on one or more motion parameters of the autonomous vehicle and a target time for the autonomous vehicle to pull-over.

In some implementations of the example method, the feasibility of the autonomous vehicle completing the stop at each respective pull-over location is indicative of a probability of the autonomous vehicle being able to travel to a stopped position at the pull-over location based on the one or more motion parameters and within the target time for the autonomous vehicle to pull-over.

In some implementations of the example method, the one or more motion parameters are indicative of at least one of: (i) a speed of the autonomous vehicle, (ii) a heading of the autonomous vehicle, or (iii) a lane of the autonomous vehicle.

In some implementations of the example method, the target time for the autonomous vehicle to pull-over is provided by a remote computing system that is remote from the autonomous vehicle.

In some implementations of the example method, (c) includes: determining a distance from the autonomous vehicle to each of the plurality of pull-over locations; and determining the one or more candidate pull-over locations based on the distance from the autonomous vehicle to each of the plurality of pull-over locations.

In some implementations of the example method, the quality of the respective candidate pull-over location is based on a width and a length of a respective candidate pull-over location.

In some implementations of the example method, the pull-over command is obtained from a remote computing system that is remote from the autonomous vehicle or is generated by a computing system onboard the autonomous vehicle, and wherein the pull-over command is generated in response to at least one of: (i) a software fault of the autonomous vehicle, (ii) a hardware fault of the autonomous vehicle, (iii) a detected environmental condition, or (iv) a collision.

In some implementations, the example method includes: (h) generating route data that is indicative of the route for the autonomous vehicle and one or more descriptors for at least one respective candidate pull-over location.

In an aspect, the present disclosure provides an example autonomous vehicle control system that includes one or more processors, and one or more tangible non-transitory computer-readable media storing instruction that are executable by the one or more processors to perform operations. The operations include: (a) obtaining a pull-over command indicating an autonomous vehicle is to pull-over to a side of a travel way; (b) in response to the pull-over command, obtaining map data indicative of a plurality of pull-over locations for the autonomous vehicle; (c) determining, from among the plurality of pull-over locations, one or more candidate pull-over locations for the autonomous vehicle based on the map data and a route of the autonomous vehicle; (d) determining a ranking of the one or more candidate pull-over locations based on (i) a feasibility of the autonomous vehicle completing a stop at each respective candidate pull-over location and (ii) a quality of each respective candidate pull-over location; (e) based on the ranking of the one or more candidate pull-over locations, determining a selected pull-over location for the autonomous vehicle; and (f) controlling a motion of the autonomous vehicle based on the selected pull-over location.

In some implementations of the example autonomous vehicle control system, the selected pull-over location includes a goal range, and (f) includes: generating a trajectory for the autonomous vehicle to travel to a stopped position within the goal range associated with the selected pull-over location; and controlling the motion of the autonomous vehicle based on the trajectory such that the autonomous vehicle reaches the stopped position within the goal range.

In some implementations of the example autonomous vehicle control system, the goal range defines an area, on a shoulder of the travel way, in which the autonomous vehicle is to stop.

In some implementations of the example autonomous vehicle control system, (d) includes: determining a rank of a respective candidate pull-over location based on one or more motion parameters of the autonomous vehicle and a respective distance for the autonomous vehicle to reach the respective candidate pull-over location.

In some implementations of the example autonomous vehicle control system, the plurality of pull-over locations are outside of a boundary defining one or more lanes of travel on the travel way.

In some implementations of the example autonomous vehicle control system, (d) includes performing a cost analysis of the one or more candidate pull-over locations, wherein a cost for a respective candidate pull-over location is based on the feasibility of the autonomous vehicle completing the stop at the respective pull-over location, the quality of the respective candidate pull-over location, and a timing or distance constraint for the autonomous vehicle to pull-over.

In some implementations of the example autonomous vehicle control system, the operations further include generating a pull-over route for the autonomous vehicle to travel to the selected pull-over location, and (f) includes controlling the motion of the autonomous vehicle in accordance with the pull-over route.

In an aspect, the present disclosure provides an example autonomous vehicle. The example autonomous vehicle includes one or more processors and one or more tangible non-transitory computer-readable media storing instructions that are executable by the one or more processors to perform operations. The operations include: (a) obtaining a pull-over command indicating the autonomous vehicle is to pull-over to a side of a travel way; (b) in response to the pull-over command, obtaining map data indicative of a plurality of pull-over locations for the autonomous vehicle; (c) determining, from among the plurality of pull-over locations, one or more candidate pull-over locations for the autonomous vehicle based on the map data and a route of the autonomous vehicle; (d) determining a ranking of the one or more candidate pull-over locations based on (i) a feasibility of the autonomous vehicle completing a stop at each respective candidate pull-over location and (ii) a quality of each respective candidate pull-over location; (e) based on the ranking of the one or more candidate pull-over locations, determining a selected pull-over location for the autonomous vehicle; and (f) controlling a motion of the autonomous vehicle based on the selected pull-over location.

In some implementations of the example autonomous vehicle, the operations further include: (g) adjusting the route of the autonomous vehicle such that the autonomous vehicle is routed to the selected pull-over location; and wherein (f) includes: generating a trajectory for the autonomous vehicle to travel to a stopped position within a goal range associated with the selected pull-over location, and controlling the motion of the autonomous vehicle based on the trajectory such that the autonomous vehicle reaches the stopped position within the goal range.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a diagram of example scenarios for an autonomous vehicle to pull-over to the side of a travel way, according to some implementations of the present disclosure;

FIG. 5 is a block diagram of an example remote computing system, according to some implementations of the present disclosure;

FIG. 6 is a block diagram of an example dataflow pipeline and system for performing a pull-over, according to some implementations of the present disclosure;

FIG. 7 illustrates example map data encoded with pull-over locations, according to some implementations of the present disclosure.

FIG. 8 illustrates an example route with candidate pull-over locations, according to some implementations of the present disclosure.

FIG. 9 is an example data structure with a ranking of candidate pull-over locations, according to some implementations of the present disclosure.

FIG. 10 illustrates an example route with a selected pull-over location, according to some implementations of the present disclosure.

FIG. 11 is a diagram of example vehicle motion trajectory to a selected pull-over location, according to some implementations of the present disclosure.

FIGS. 12-15 are flowcharts of example methods for controlling an autonomous vehicle to pull-over, according to some implementations of the present disclosure; and

FIG. 16 is a block diagram of an example computing system, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

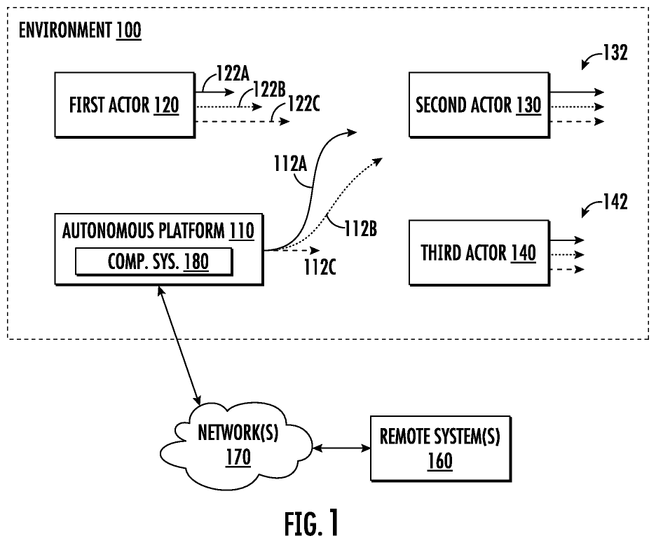

With reference to FIGS. 1-14, example implementations of the present disclosure are discussed in further detail. FIG. 1 is a block diagram of an example operational scenario, according to some implementations of the present disclosure. In the example operational scenario, an environment 100 contains an autonomous platform 110 and a number of objects, including first actor 120, second actor 130, and third actor 140. In the example operational scenario, autonomous platform 110 can move through environment 100 and interact with the object(s) that are located within environment 100 (e.g., first actor 120, second actor 130, third actor 140, etc.). Autonomous platform 110 can optionally be configured to communicate with remote system(s) 160 through network(s) 170.

Environment 100 may be or include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

Autonomous platform 110 can be any type of platform configured to operate within environment 100. For example, autonomous platform 110 can be a vehicle configured to autonomously perceive and operate within environment 100. The vehicles can be a ground-based autonomous vehicle such as, for example, an autonomous car, truck, van, etc. Autonomous platform 110 can be an autonomous vehicle that can control, be connected to, or be otherwise associated with implements, attachments, and/or accessories for transporting people or cargo. This can include, for example, an autonomous tractor optionally coupled to a cargo trailer. Additionally, or alternatively, autonomous platform 110 can be any other type of vehicle such as one or more aerial vehicles, water-based vehicles, space-based vehicles, other ground-based vehicles, etc.

Autonomous platform 110 can be configured to communicate with remote system(s) 160. For instance, remote system(s) 160 can communicate with autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, remote system(s) 160 can provide data indicating tasks that autonomous platform 110 should perform. For example, as further described herein, remote system(s) 160 can provide data indicating that autonomous platform 110 is to perform a trip/service such as a user transportation trip/service, delivery trip/service (e.g., for cargo, freight, items), etc.

Autonomous platform 110 can communicate with remote system(s) 160 using network(s) 170. Network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from autonomous platform 110.

As shown for example in FIG. 1, environment 100 can include one or more objects. The object(s) may be objects not in motion or not predicted to move (“static objects”) or object(s) in motion or predicted to be in motion (“dynamic objects” or “actors”). In some implementations, environment 100 can include any number of actor(s) such as, for example, one or more pedestrians, animals, vehicles, etc. The actor(s) can move within the environment according to one or more actor trajectories. For instance, first actor 120 can move along any one of first actor trajectories 122A-C, second actor 130 can move along any one of second actor trajectories 132, third actor 140 can move along any one of third actor trajectories 142, etc.

As further described herein, autonomous platform 110 can utilize its autonomy system(s) to detect these actors (and their movement) and plan its motion to navigate through environment 100 according to one or more platform trajectories 112A-C. Autonomous platform 110 can include onboard computing system(s) 180. Onboard computing system(s) 180 can include one or more processors and one or more memory devices. The one or more memory devices can store instructions executable by the one or more processors to cause the one or more processors to perform operations or functions associated with autonomous platform 110, including implementing its autonomy system(s).

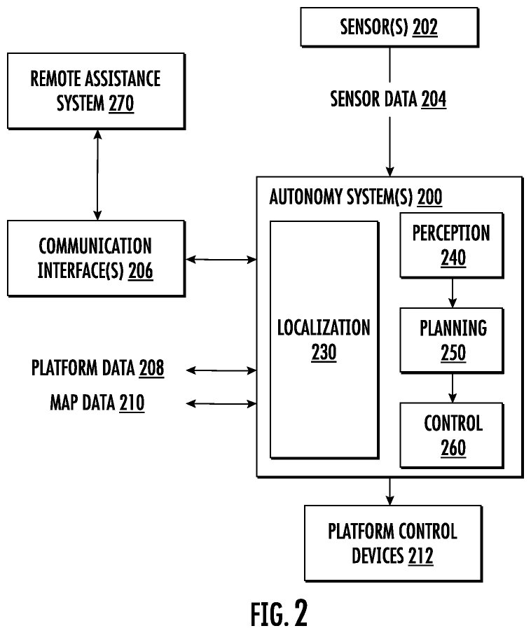

FIG. 2 is a block diagram of an example autonomy system 200 for an autonomous platform, according to some implementations of the present disclosure. In some implementations, autonomy system 200 can be implemented by a computing system of the autonomous platform (e.g., onboard computing system(s) 180 of autonomous platform 110). Autonomy system 200 can operate to obtain inputs from sensor(s) 202 or other input devices. In some implementations, autonomy system 200 can additionally obtain platform data 208 (e.g., map data 210) from local or remote storage. Autonomy system 200 can generate control outputs for controlling the autonomous platform (e.g., through platform control devices 212, etc.) based on sensor data 204, map data 210, or other data. Autonomy system 200 can include different subsystems for performing various autonomy operations. The subsystems may include a localization system 230, a perception system 240, a planning system 250, and a control system 260. Localization system 230 can determine the location of the autonomous platform within its environment; perception system 240 can detect, classify, and track objects and actors in the environment; planning system 250 can determine a trajectory for the autonomous platform; and control system 260 can translate the trajectory into vehicle controls for controlling the autonomous platform. Autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of autonomy system 200 can be shared among its subsystems, or a subsystem can have a set of dedicated computing resources.

In some implementations, autonomy system 200 can be implemented for or by an autonomous vehicle (e.g., a ground-based autonomous vehicle). Autonomy system 200 can perform various processing techniques on inputs (e.g., sensor data 204, map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

Autonomy system 200 can be located onboard (e.g., on or within) an autonomous platform and can be configured to operate the autonomous platform in various environments. The environment may be a real-world environment or a simulated environment. In some implementations, one or more simulation computing devices can simulate one or more of: sensors 202, sensor data 204, communication interface(s) 206, platform data 208, or platform control devices 212 for simulating operation of autonomy system 200.

In some implementations, autonomy system 200 can communicate with one or more networks or other systems with communication interface(s) 206. Communication interface(s) 206 can include any suitable components for interfacing with one or more network(s) (e.g., network(s) 170 of FIG. 1, etc.), including, for example, transmitters, receivers, ports, controllers, antennas, or other suitable components that can help facilitate communication. In some implementations, communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, autonomy system 200 can use communication interface(s) 206 to communicate with one or more computing devices that are remote from the autonomous platform (e.g., remote system(s) 160) over one or more network(s) (e.g., network(s) 170). For instance, in some examples, one or more inputs, data, or functionalities of autonomy system 200 can be supplemented or substituted by a remote system communicating over communication interface(s) 206. For instance, in some implementations, map data 210 can be downloaded over a network to a remote system using communication interface(s) 206. In some examples, one or more of localization system 230, perception system 240, planning system 250, or control system 260 can be updated, influenced, nudged, communicated with, etc. by a remote system for assistance, maintenance, situational response override, management, etc.

Sensor(s) 202 can be located onboard the autonomous platform. In some implementations, sensor(s) 202 can include one or more types of sensor(s). For instance, one or more sensors can include image capturing device(s) (e.g., visible spectrum cameras, infrared cameras, etc.). Additionally, or alternatively, sensor(s) 202 can include one or more depth capturing device(s). For example, sensor(s) 202 can include one or more Light Detection and Ranging (LIDAR) sensor(s) or Radio Detection and Ranging (RADAR) sensor(s). Sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of sensor(s) 202 for capturing depth information can be fixed to a rotational device in order to rotate sensor(s) 202 about an axis. Sensor(s) 202 can be rotated about the axis while capturing data in interval sector packets descriptive of different portions of a three-hundred-and-sixty-degree view of a surrounding environment of the autonomous platform. In some implementations, one or more of sensor(s) 202 for capturing depth information can be solid state.

Sensor(s) 202 can be configured to capture sensor data 204 indicating or otherwise being associated with at least a portion of the environment of the autonomous platform. Sensor data 204 can include image data (e.g., 2D camera data, video data, etc.), RADAR data, LIDAR data (e.g., 3D point cloud data, etc.), audio data, or other types of data. In some implementations, autonomy system 200 can obtain input from additional types of sensors, such as inertial measurement units (IMUs), altimeters, inclinometers, odometry devices, location or positioning devices (e.g., GPS, compass), wheel encoders, or other types of sensors. In some implementations, autonomy system 200 can obtain sensor data 204 associated with particular component(s) or system(s) of an autonomous platform. This data can indicate, for example, wheel speed, component temperatures, steering angle, cargo or passenger status, etc. In some implementations, autonomy system 200 can obtain sensor data 204 associated with ambient conditions, such as environmental or weather conditions. In some implementations, sensor data 204 can include multi-modal sensor data. The multi-modal sensor data can be obtained by at least two different types of sensor(s) (e.g., of sensors 202) and can indicate static object(s) or actor(s) within an environment of the autonomous platform. The multi-modal sensor data can include at least two types of sensor data (e.g., camera and LIDAR data). In some implementations, the autonomous platform can utilize sensor data 204 for sensors that are remote from (e.g., offboard) the autonomous platform. This can include for example, sensor data 204 captured by a different autonomous platform.

Autonomy system 200 can obtain map data 210 associated with an environment in which the autonomous platform was, is, or will be located. Map data 210 can provide information about an environment or a geographic area. For example, map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, map data 210 can include high-definition map information. Additionally, or alternatively, map data 210 can include sparse map data (e.g., lane graphs, etc.). In some implementations, sensor data 204 can be fused with or used to update map data 210 in real-time.

Autonomy system 200 can include localization system 230, which can provide an autonomous platform with an understanding of its location and orientation in an environment. In some examples, localization system 230 can support one or more other subsystems of autonomy system 200, such as by providing a unified local reference frame for performing, e.g., perception operations, planning operations, or control operations.

In some implementations, localization system 230 can determine a current position of the autonomous platform. A current position can include a global position (e.g., respecting a georeferenced anchor, etc.) or relative position (e.g., respecting objects in the environment, etc.). Localization system 230 can generally include or interface with any device or circuitry for analyzing a position or change in position of an autonomous platform (e.g., autonomous ground-based vehicle, etc.). For example, localization system 230 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of autonomy system 200 or provided to a remote computing system (e.g., using communication interface(s) 206).

In some implementations, localization system 230 can register relative positions of elements of a surrounding environment of an autonomous platform with recorded positions in map data 210. For instance, localization system 230 can process sensor data 204 (e.g., LIDAR data, RADAR data, camera data, etc.) for aligning or otherwise registering to a map of the surrounding environment (e.g., from map data 210) to understand the autonomous platform's position within that environment. Accordingly, in some implementations, the autonomous platform can identify its position within the surrounding environment (e.g., across six axes, etc.) based on a search over map data 210. In some implementations, given an initial location, localization system 230 can update the autonomous platform's location with incremental re-alignment based on recorded or estimated deviations from the initial location. In some implementations, a position can be registered directly within map data 210.

In some implementations, map data 210 can include a large volume of data subdivided into geographic tiles, such that a desired region of a map stored in map data 210 can be reconstructed from one or more tiles. For instance, a plurality of tiles selected from map data 210 can be stitched together by autonomy system 200 based on a position obtained by localization system 230 (e.g., a number of tiles selected in the vicinity of the position).

In some implementations, localization system 230 can determine positions (e.g., relative or absolute) of one or more attachments or accessories for an autonomous platform. For instance, an autonomous platform can be associated with a cargo platform, and localization system 230 can provide positions of one or more points on the cargo platform. For example, a cargo platform can include a trailer or other device towed or otherwise attached to or manipulated by an autonomous platform, and localization system 230 can provide for data describing the position (e.g., absolute, relative, etc.) of the autonomous platform as well as the cargo platform. Such information can be obtained by the other autonomy systems to help operate the autonomous platform.

Autonomy system 200 can include perception system 240, which can allow an autonomous platform to detect, classify, and track objects and actors in its environment. Environmental features or objects perceived within an environment can be those within the field of view of sensor(s) 202 or predicted to be occluded from sensor(s) 202. This can include object(s) not in motion or not predicted to move (static objects) or object(s) in motion or predicted to be in motion (dynamic objects/actors).

Perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, perception system 240 can determine the state(s) using one or more algorithms or machine-learned models configured to identify/classify objects based on inputs from sensor(s) 202. The perception system can use different modalities of sensor data 204 to generate a representation of the environment to be processed by the one or more algorithms or machine-learned models. In some implementations, state(s) for one or more identified or unidentified objects can be maintained and updated over time as the autonomous platform continues to perceive or interact with the objects (e.g., maneuver with or around, yield to, etc.). In this manner, perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

Autonomy system 200 can include planning system 250, which can be configured to determine how the autonomous platform is to interact with and move within its environment. Planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of planning system 250. A motion trajectory can be defined by one or more waypoints (with associated coordinates). The waypoint(s) can be future location(s) for the autonomous platform. The motion plans can be continuously generated, updated, and considered by planning system 250.

Planning system 250 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

Planning system 250 can determine a desired trajectory for executing a strategy. For instance, planning system 250 can obtain one or more trajectories for executing one or more strategies. Planning system 250 can evaluate trajectories or strategies (e.g., with scores, costs, rewards, constraints, etc.) and rank them. For instance, planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, planning system 250 can utilize static cost(s) to evaluate trajectories for the autonomous platform (e.g., “avoid lane boundaries,” “minimize jerk,” etc.). Additionally, or alternatively, planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). Planning system 250 can rank trajectories based on one or more static costs, one or more dynamic costs, or a combination thereof. Planning system 250 can select a motion plan (and a corresponding trajectory) based on a ranking of a plurality of candidate trajectories. In some implementations, planning system 250 can select a highest ranked candidate, or a highest ranked feasible candidate.

Planning system 250 can then validate the selected trajectory against one or more constraints before the trajectory is executed by the autonomous platform.

To help with its motion planning decisions, planning system 250 can be configured to perform a forecasting function. Planning system 250 can forecast future state(s) of the environment. This can include forecasting the future state(s) of other actors in the environment. In some implementations, planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally, or alternatively, the probabilities can include probabilities conditioned on trajectory options available to one or more other actors.

In some implementations, planning system 250 can perform interactive forecasting. Planning system 250 can determine a motion plan for an autonomous platform with an understanding of how forecasted future states of the environment can be affected by execution of one or more candidate motion plans. By way of example, with reference again to FIG. 1, autonomous platform 110 can determine candidate motion plans corresponding to a set of platform trajectories 112A-C that respectively correspond to first actor trajectories 122A-C for first actor 120, trajectories 132 for second actor 130, and trajectories 142 for third actor 140 (e.g., with respective trajectory correspondence indicated with matching line styles). For instance, autonomous platform 110 (e.g., using its autonomy system 200) can forecast that a platform trajectory 112A to more quickly move autonomous platform 110 into the area in front of first actor 120 is likely associated with first actor 120 decreasing forward speed and yielding more quickly to autonomous platform 110 in accordance with first actor trajectory 122A. Additionally or alternatively, autonomous platform 110 can forecast that a platform trajectory 112B to gently move autonomous platform 110 into the area in front of first actor 120 is likely associated with first actor 120 slightly decreasing speed and yielding slowly to autonomous platform 110 in accordance with first actor trajectory 122B. Additionally or alternatively, autonomous platform 110 can forecast that a platform trajectory 112C to remain in a parallel alignment with first actor 120 is likely associated with first actor 120 not yielding any distance to autonomous platform 110 in accordance with first actor trajectory 122C. Based on comparison of the forecasted scenarios to a set of desired outcomes (e.g., by scoring scenarios based on a cost or reward), planning system 250 can select a motion plan (and its associated trajectory) in view of the autonomous platform's interaction with environment 100. In this manner, for example, autonomous platform 110 can interleave its forecasting and motion planning functionality.

To implement selected motion plan(s), autonomy system 200 can include a control system 260 (e.g., a vehicle control system). Generally, control system 260 can provide an interface between autonomy system 200 and platform control devices 212 for implementing the strategies and motion plan(s) generated by planning system 250. For instance, control system 260 can implement the selected motion plan/trajectory to control the autonomous platform's motion through its environment by following the selected trajectory (e.g., the waypoints included therein). Control system 260 can, for example, translate a motion plan into instructions for the appropriate platform control devices 212 (e.g., acceleration control, brake control, steering control, etc.). By way of example, control system 260 can translate a selected motion plan into instructions to adjust a steering component (e.g., a steering angle) by a certain number of degrees, apply a certain magnitude of braking force, increase/decrease speed, etc. In some implementations, control system 260 can communicate with platform control devices 212 through communication channels including, for example, one or more data buses (e.g., controller area network (CAN), etc.), onboard diagnostics connectors (e.g., OBD-II, etc.), or a combination of wired or wireless communication links. Platform control devices 212 can send or obtain data, messages, signals, etc. to or from autonomy system 200 (or vice versa) through the communication channel(s).

Autonomy system 200 can receive, through communication interface(s) 206, assistive signal(s) from remote assistance system 270. Remote assistance system 270 can communicate with autonomy system 200 over a network (e.g., as a remote system 160 over network 170). In some implementations, autonomy system 200 can initiate a communication session with remote assistance system 270. For example, autonomy system 200 can initiate a session based on or in response to a trigger. In some implementations, the trigger may be an alert, an error signal, a map feature, a request, a location, a traffic condition, a road condition, etc.

After initiating the session, autonomy system 200 can provide context data to remote assistance system 270. The context data may include sensor data 204 and state data of the autonomous platform. For example, the context data may include a live camera feed from a camera of the autonomous platform and the autonomous platform's current speed. An operator (e.g., human operator) of remote assistance system 270 can use the context data to select assistive signals. The assistive signal(s) can provide values or adjustments for various operational parameters or characteristics for autonomy system 200. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist autonomy system 200.

Autonomy system 200 can use the assistive signal(s) for input into one or more autonomy subsystems for performing autonomy functions. For instance, planning subsystem 250 can receive the assistive signal(s) as an input for generating a motion plan. For example, assistive signal(s) can include constraints for generating a motion plan. Additionally, or alternatively, assistive signal(s) can include cost or reward adjustments for influencing motion planning by planning subsystem 250. Additionally, or alternatively, assistive signal(s) can be considered by autonomy system 200 as suggestive inputs for consideration in addition to other received data (e.g., sensor inputs, etc.).

Autonomy system 200 may be platform agnostic, and control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

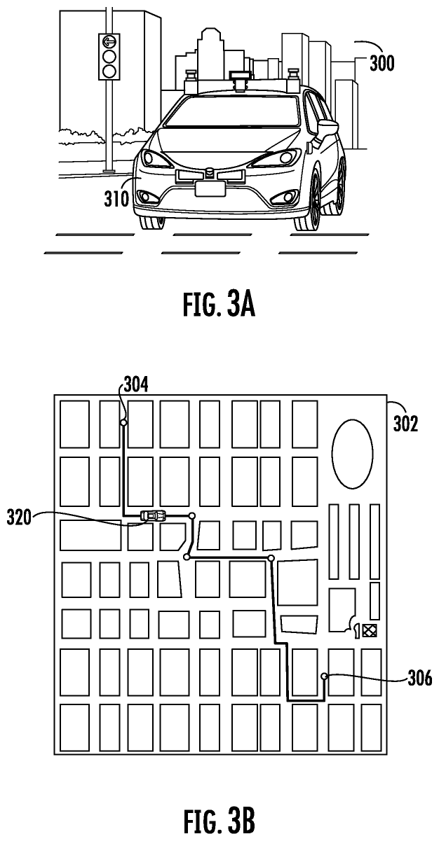

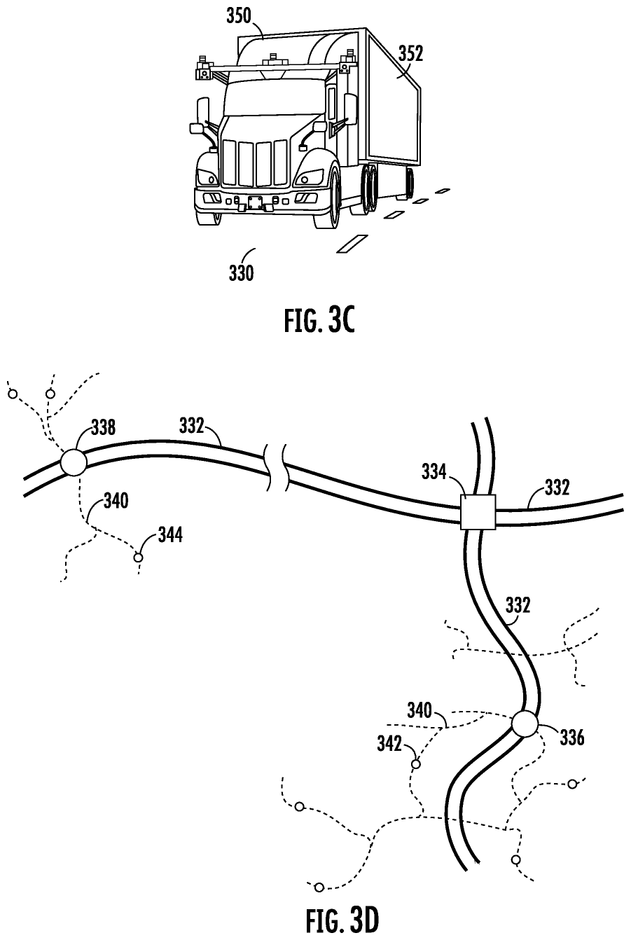

For example, with reference to FIG. 3A, an operational environment can include a dense environment 300. An autonomous platform can include an autonomous vehicle 310 controlled by autonomy system 200. In some implementations, autonomous vehicle 310 can be configured for maneuverability in a dense environment, such as with a configured wheelbase or other specifications. In some implementations, autonomous vehicle 310 can be configured for transporting cargo or passengers. In some implementations, autonomous vehicle 310 can be configured to transport numerous passengers (e.g., a passenger van, a shuttle, a bus, etc.). In some implementations, autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of dense environment 300 is shown overlaid with an example trip/service between a first location 304 and a second location 306. The example trip/service can be assigned, for example, to an autonomous vehicle 320 by a remote computing system. Autonomous vehicle 320 can be, for example, the same type of vehicle as autonomous vehicle 310. The example trip/service can include transporting passengers or cargo between first location 304 and second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by autonomy system 200. This can include an autonomous tractor for an autonomous truck. In some implementations, autonomous vehicle 350 can be configured for high payload transport (e.g., transporting freight or other cargo or passengers in quantity), such as for long distance, high payload transport. For instance, autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., autonomous vehicle 310 or autonomous vehicle 350) can be assigned an example trip/service to traverse one or more travel ways 332 (optionally connected by interchange 334) to transport cargo between transfer hub 336 and transfer hub 338. For instance, in some implementations, the example trip/service includes a cargo delivery/transport service, such as a freight delivery/transport service. The example trip/service can be assigned by a remote computing system. In some implementations, transfer hub 336 can be an origin point for cargo (e.g., a depot, a warehouse, a facility, etc.) and transfer hub 338 can be a destination point for cargo (e.g., a retailer, etc.). However, in some implementations, transfer hub 336 can be an intermediate point along a cargo item's ultimate journey between its respective origin and its respective destination. For instance, a cargo item's origin can be situated along access travel ways 340 at location 342. The cargo item can accordingly be transported to transfer hub 336 (e.g., by a human-driven vehicle, by autonomous vehicle 310, etc.) for staging. At transfer hub 336, various cargo items can be grouped or staged for longer distance transport over travel ways 332.

In some implementations of an example trip/service, a group of staged cargo items can be loaded onto an autonomous vehicle (e.g., autonomous vehicle 350) for transport to one or more other transfer hubs, such as transfer hub 338. For instance, although not depicted, it is to be understood that open travel way environment 330 can include more transfer hubs than transfer hubs 336 and 338 and can include more travel ways 332 interconnected by more interchanges 334. A simplified map is presented here for purposes of clarity only. In some implementations, one or more cargo items transported to transfer hub 338 can be distributed to one or more local destinations (e.g., by a human-driven vehicle, by autonomous vehicle 310, etc.), such as along access travel ways 340 to location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

To improve the performance of an autonomous platform, such as an autonomous vehicle controlled at least in part using autonomy system 200 (e.g., autonomous vehicles 310 or 350), a computing system can implement the technology of the present disclosure for intelligently selecting a pull-over location and controlling the autonomous platform thereto.

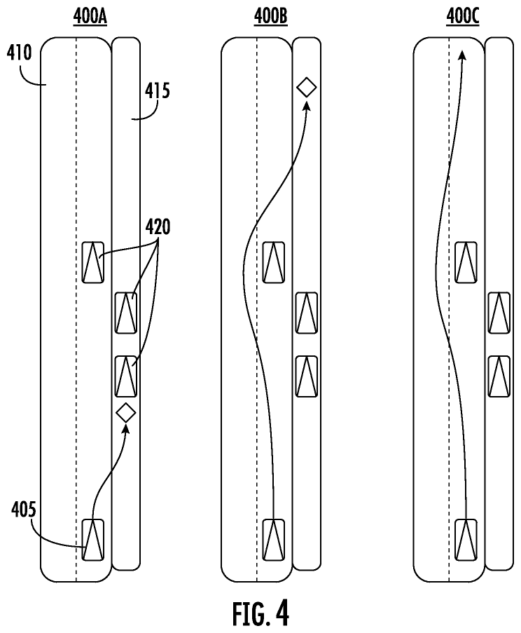

FIG. 4 is a diagram of an autonomous vehicle 405 operating on travel way 410. The autonomous vehicle 405 may represent the autonomous vehicles previously described herein. The autonomous vehicle 405 may experience various conditions such that it would be preferable for the autonomous vehicle to pull-over to a side 415 (e.g., shoulder) of the travel way 410 (e.g., a road). The conditions may be perceived/detected by the onboard computing system of the autonomous vehicle 405 or a remote computing system that is remote from the autonomous vehicle 405. As described herein, the remote computing system may include a remote assistance system 270, which is configured to monitor and assist the autonomous vehicle 405 from a remote location. The remote computing system can communicate, to the autonomous vehicle 405, data indicative of the conditions.

It may be preferable for the autonomous vehicle 405 to pull-over in response to a detected environmental condition. This can include, for example, the presence of an emergency vehicle. An emergency vehicle may be detected within the surrounding environment of the autonomous vehicle 405. The emergency vehicle may be detected by the vehicle's onboard computing system based on an audible signal, a vehicle-to-vehicle communication, object perception, etc. Additionally, or alternatively, the remote computing system may receive a communication from an emergency response service/system indicating the location of the emergency vehicle. The emergency vehicle may be traveling in the same direction as the autonomous vehicle 405 or in the opposite direction.

In another example, the detected environmental condition can include inclement weather. The potential inclement weather may be determined based on information provided by a weather service. The information may include the timing, location, and type of potential inclement weather. For instance, a weather service can issue a tornado or hailstorm warning for the geographic area in which the autonomous vehicle 405 is traveling. This warning may be provided directly to the autonomous vehicle 405 or to the remote computing system. Additionally, or alternatively, a remote computing system can obtain weather radar data to determine the estimated timing and location of potential inclement weather.

Additionally, or alternatively, the onboard sensors of the autonomous vehicle 405 can be utilized to detect inclement weather. For instance, the vehicle's onboard sensor may obtain sensor data indicative of environmental pressure, image data of the surrounding environment, audible recordings, etc. The sensor data may be processed to predict or perceive extremely heavy rain or hail within the vehicle's surrounding environment, for example.

In another example, it may be preferable for the autonomous vehicle 405 to pull-over in response to a detected environmental condition such as travel way blockage. This may include a blockage that prevents the autonomous vehicle 405 from traveling in a certain lane or traveling on the road at all. The blockage may be detected by the vehicle's onboard computing system based on sensor data that captures images of the blockage or via a traffic service that provides an indication of the blockage to the autonomous vehicle 405 or the remote computing system.

In another example, it may be preferable for the autonomous vehicle to pull-over based on a software fault of the autonomous vehicle. The software fault may include an error associated with the software running onboard the autonomous vehicle. The software error may not be a critical error that limits the safe operation of the autonomous vehicle. The software error may be one that at least partially affects the ability of the autonomous vehicle to perform a function using the associated software. This may include a hindrance to the vehicle's autonomy functions, an error that increases onboard latency, an error that limits the ability of the vehicle to transmit data offboard the vehicle, etc.

It may be preferable for the autonomous vehicle to pull-over based on a hardware fault of the autonomous vehicle. The hardware fault may include an error or damage to the hardware located onboard the autonomous vehicle. The hardware fault may not be a critical error that limits the safe operation of the autonomous vehicle. The fault can be one that at least partially affects the ability of the autonomous vehicle to perform a function using the associated hardware. This can include, for example, a fault of the vehicle's LIDAR sensors, RADAR sensors, cameras, communications hardware (e.g., antenna) or other electrical/mechanical components.

It may be preferable for the autonomous vehicle to pull-over based on a collision. The collision may be between two objects (e.g., two other vehicles) within the surrounding environment of the autonomous vehicle or involve the autonomous vehicle.

Based on the conditions, the autonomous vehicle 400 may obtain a pull-over command indicating the autonomous vehicle 405 is to pull-over to a side of the travel way. The pull-over command can include an instruction for the autonomous vehicle 405 to pull-over, which can include the autonomous vehicle 405 performing a maneuver that positions the autonomous vehicle 405 out of the lane boundaries onto the side 415 (e.g., shoulder) of the travel way 410.

The pull-over command can indicate a time or distance constraint for pulling-over. For example, the instruction may include a target time for the autonomous vehicle 405 to pull-over. Additionally or alternatively, the instruction may include a target distance within which the autonomous vehicle 405 is to pull-over. The target time and the target distance can be proportional to the severity of the condition. For instance, the instructions may specify that the autonomous vehicle 405 should pull-over within the next 5 minutes or within the next 2 km, given a tornado warning.

The pull-over command can be generated by one or more computing sources. For instance, the computing system of the autonomous vehicle 405 can generate the pull-over command based on its determination that conditions exist which would make it preferable for the autonomous vehicle 405 to pull-over. As described herein, these conditions can be detected by the computing system of the autonomous vehicle 405 or communicated to the computing system of the autonomous vehicle 405 from the remote computing system.

Additionally or alternatively, the pull-over command can be obtained from the remote computing system. For instance, the remote computing system can generate the pull-over command based on its determination that conditions exist which would make it preferable for the autonomous vehicle 405 to pull-over. The remote computing system can transmit the pull-over command to the autonomous vehicle over a network.

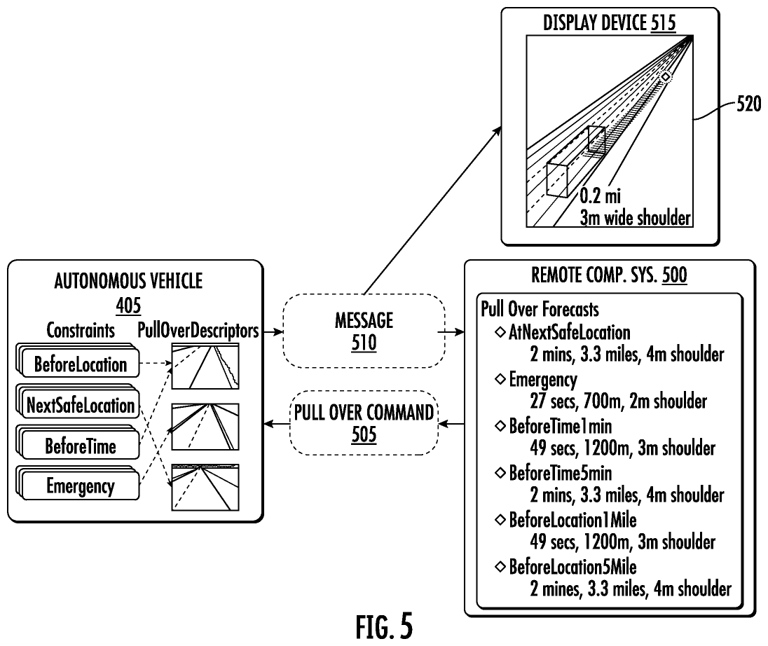

FIG. 5 depicts an example remote computing system 500 according to some aspects of the present disclosure. The remote computing system 500 may include a remote assistance system. The remote computing system 500 may be configured to determine pull-over forecasts that indicate constraints for the autonomous vehicle to pull-over. The remote computing system 500 may determine a pull-over location for the autonomous vehicle 405 according to the technology further described herein.

The remote computing system 500 can transmit a pull-over command 505 to the autonomous vehicle 405. The pull-over command 505 can instruct the autonomous vehicle 405 to pull-over (e.g., pull to a shoulder). The pull-over command 505 can include one or more time or distance constraints, as described herein. The pull-over command 505 can indicate a pull-over location for the autonomous vehicle 405 in the event that the remote computing system 500 is configured to perform the functions and operations described herein for selecting a pull-over location.

With reference again to FIG. 4, the autonomous vehicle 405 may need to identify an appropriate pull-over location in response to a pull-over command. Based on the current traffic conditions and travel way 410, the autonomous vehicle 405 may have one or more options for pulling over to the side 415. For example, scenarios 400A-C show objects 420 (e.g., construction vehicles) that make up a work convoy. As shown, the work convoy includes objects 420 on the side 415 and within a lane of the travel way 410. Given the position of the work convoy relative to the travel way 410, the autonomous vehicle 405 may attempt to pull-over to the side 415 before the work convoy as shown in scenario 400A, the autonomous vehicle 405 may attempt to pull-over to the side 415 immediately after the work convoy as shown in scenario 400B, or the autonomous vehicle 405 may attempt to pass the work convoy and pull-over at a future time further along the travel way 410.

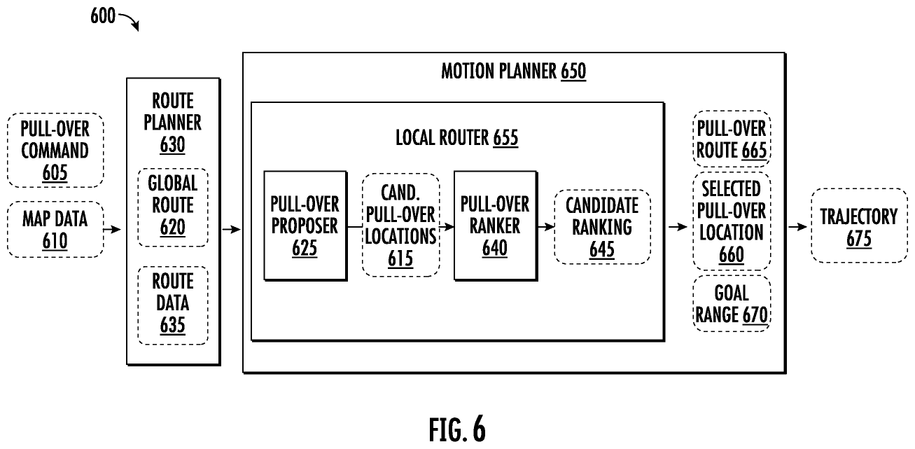

The autonomous vehicle 405 may include a computing system 600 that is configured to determine an appropriate pull-over location, as shown in FIG. 6. The computing system 600 can be an autonomous vehicle control system that includes one or more processors and one or more tangible non-transitory computer-readable media storing instruction that are executable by the one or more processors to perform operations such as those described herein for selecting a pull-over location and planning the motion accordingly. The computing system 600 can be included in an onboard computing system of the autonomous vehicle 405 (e.g., within the autonomy system 200).

The computing system 600 can be configured to obtain a pull-over command 605 indicating the autonomous vehicle 405 is to pull-over to the side 415 of the travel way 410, intelligently select a pull-over location for the autonomous vehicle 405, and plan the vehicle's motion accordingly.

For instance, in response to the pull-over command 605, the computing system 600 can obtain map data 610 indicative of a plurality of pull-over locations for the autonomous vehicle 405. The map data 610 can indicate pull-over locations beyond those that may be included within a local map (e.g., beyond 1000 m from the vehicle). In this way, the map data 610 can allow the autonomous vehicle 405 to search and stop at preferred pull-over locations beyond those immediately nearby, and prioritize preferred pull-over locations over unpreferred pull-over locations.

The map data 610 can be generated offline and provided to the autonomous vehicle 405 over a network. For instance, the map data 610 can be labeled with a plurality of pull-over locations that are suitable for the autonomous vehicle 405. The pull-over locations can include, for example, locations on a shoulder of a road where a vehicle can pull off of a travel way. The plurality of pull-over locations can be locations that are suitable for the autonomous vehicle 405. For instance, in the event the autonomous vehicle 405 is an autonomous truck, the suitable pull-over locations may include areas within a shoulder that have the physical dimensions for the entire autonomous truck (and trailer) to stop outside the lanes of travel. At least some pull-over location can include a threshold clearance margin (e.g., 0.5 m) from the closest lane boundary.

The pull-over locations can be manually identified and labeled (by humans) based on image data indicative of the area. The human labels can be stored in a data structure and used to produce a distribution of pull-over locations within a geographic area.

For each of the pull-over locations, the map data 610 can be encoded with descriptors associated with the respective pull-over location. This can include information such as the physical dimensions (e.g., length, width) of the area for stopping at the pull-over location, narrowing of the area (e.g., gradients in width), speed constraints (e.g., maximum approach speed), off-set/clearance distances (e.g., from lane boundaries, guardrails, other barriers), or other pre-selected criteria. The descriptors can include an identifier for each of the pull-over locations.

The map data 610 can be a lightweight representation of a denser map of the geographic area in which the autonomous vehicle 405 is/will be traveling. The offline map can include a dense sampling of pull-over locations that would be computationally expensive to process onboard the autonomous vehicle 405. The map data 610 can include a map layer that indicates the plurality of pull-over locations and the respective, low-dimension descriptors for each of the pull-over locations. The low-dimension descriptors can include, for example, two dimensions. This can include position (e.g., lat./long.) and/or time.

The map data 610 utilized by the autonomous vehicle 405 may contain metadata that allows the computing system 600 to query the map to understand which pull-over locations (and their associated descriptors) are associated with a given route/path segment, without deserializing the map payload provided to the autonomous vehicle 405. For example, the metadata can include path segment identifiers for different respective segments. The path segment identifiers can be utilized to query a global map to identify the pull-over locations associated with a particular segment. The global map can store the descriptors for each of the pull-over locations. Thus, the autonomous vehicle 405 can utilize the metadata to quickly access the descriptors for a relevant segment as the autonomous vehicle 405 travels along a route and understand where a particular pull-over location is along the vehicle's route.

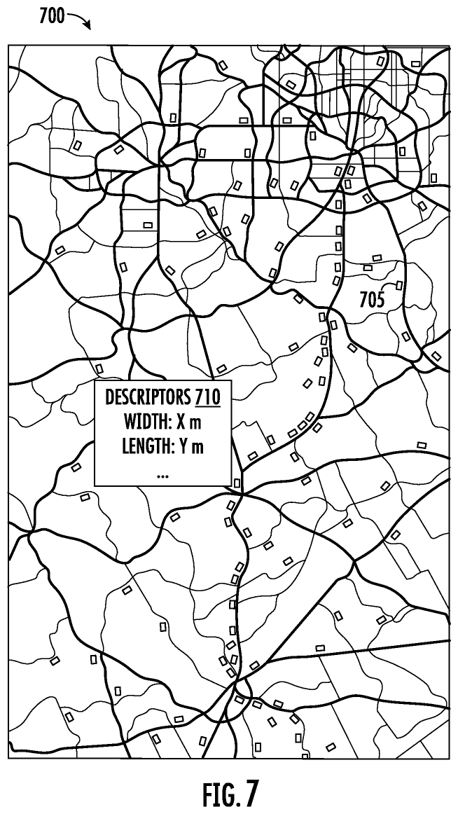

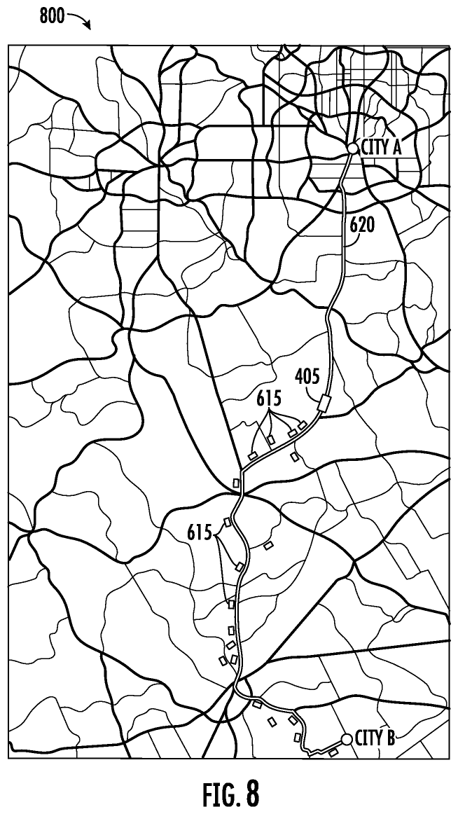

FIG. 7 is a diagram 700 of example map data 610 with a plurality of pull-over locations 705 encoded within the depicted map. Each of the respective pull-over locations 705 can be encoded with descriptors 710 such as the width and length of the pull-over location and/or other descriptors. The plurality of pull-over locations 705 can be outside of a boundary defining one or more lanes of travel on a travel way.

Returning to FIG. 6, the computing system 600 can determine, from among the plurality of pull-over locations 705, one or more candidate pull-over locations 615 for the autonomous vehicle 405 based on the map data 610 and a route 630 of the autonomous vehicle 405. To help do so, the computing system 600 can include a route planner 630 and a pull-over proposer 625, which can be a system/module included within a local router 655 of the autonomous vehicle 405.

The route planner 630 can be configured to plan a route 620 for the autonomous vehicle 405 to travel from one location to another. The route planner 630 can determine the route 620 based on the map data 610, current or future traffic conditions, a current location of the autonomous vehicle 405, fueling/charging needs of the autonomous vehicle 405, etc. The route planner 630 can query a locally or remotely stored database to identify a precomputed route between an origin and a destination. Additionally, or alternatively, the route planner 630 may be configured to submit a request to a remote computing source (e.g., hosting a routing service) to request the route 620 for the autonomous vehicle 405.

The route 620 can be, for example, a global route that routes the autonomous vehicle 405 from an origin to a destination. For example, as depicted in FIG. 8, the route 620 can be a global route for the autonomous vehicle 405 to follow in order to travel from City A to City B.

Returning to FIG. 6, the computing system 600 can be configured to identify candidate pull-over locations 615 based on the map data 610. As an initial operation, the route planner 630 can coarsely filter the plurality of pull-over locations 705. The route planner 630 can be configured to identify an initial plurality of pull-over locations for the autonomous vehicle 405 based on the map data 610. The route planner 630 can process the map data 610 to determine which of the plurality of pull-over locations 705 are accessible to the autonomous vehicle 405 along its route 620 (e.g., the global route the autonomous vehicle 405 is currently, or will be, traveling to go from City A to City B).

The route planner 630 can filter the plurality of pull-over locations 705 based on the route 620. For example, the route planner 630 can filter the plurality of pull-over locations 705 based on their distance from the route 620 to remove pull-over locations that are too far from the route 620. This can be those that are beyond a threshold distance (or driving time) from the route 620. The pull-over proposer 625 can filter out pull-over locations 705 that may be too far from the route 620 such that given the current fuel/charge level of the autonomous vehicle 405, the autonomous vehicle 405 may not have sufficient fuel/charge to return to the route 620 or to reach a fueling/charging station (after pulling over).

In some implementations, the route planner 630 can disregard any pull-over locations 705 that are behind the current location of the autonomous vehicle 405 on the route 620. A pull-over location 705 can be considered “behind” the autonomous vehicle 405 if traveling to the pull-over location 705 would require the autonomous vehicle 405 to turn around and travel in the opposite direction of the route 602 beyond a nominal amount (e.g., beyond just performing a U turn to properly reach a pull-over location located nearby the route once the vehicle exits a highway).

The route data 635 can include all the pull-over locations along the route 602 that are not completely behind the autonomous vehicle's location, including pull-over locations that are “split” by the autonomous vehicle. “Split” pull-over locations may be those that are partially in front of and partially behind the autonomous vehicle.

The computing system 600 can generate route data 635 that is indicative of the route 620 for the autonomous vehicle 405 and one or more descriptors 710 of the respective candidate pull-over location(s) 705. For instance, the route planner 630 can append the descriptors 710 of the candidate pull-over locations 615 to data indicative of the vehicle's global route and store this information as route data 635.

FIG. 8 depicts the route data 635. The candidate pull-over locations 615 (and their respective descriptors) can be appended to and stored with the route 620 as the route data 635.

Returning to FIG. 6, the route planner 630 can provide the route data 635 to the local router 655, which can include the pull-over proposer 625. The pull-over proposer 625 can be configured to identify candidate pull-over locations 615 for the autonomous vehicle 405 based on the route data 635. The pull-over proposer 625 can determine the candidate pull-over locations 615 based on the respective descriptors 710 associated with each pull-over location 705. For instance, as described herein, the descriptors 710 can be indicative of a location (e.g., lat./long. coordinates) of the pull-over location 705, a width of the pull-over location 705, a length of the pull-over location 705, etc. For example, the pull-over proposer 625 can determine the distance from the autonomous vehicle 405 to each of the pull-over locations 705 based on their respective location descriptors encoded in the route data 635, or at least the pull-over locations 705 within a threshold distance of the route 620 (e.g., within 1, 2, 3 km, etc.).

The pull-over proposer 625 can further filter the plurality of pull-over locations 705 to remove portions of certain candidate pull-over locations. For example, the pull-over proposer 625 can filter out the portions of the “split” pull-over locations that are behind the current position of the autonomous vehicle 405. The candidate pull-over locations 615 can include the portions of the “split” pull-over locations that are in front of the autonomous vehicle 405.

To determine which candidate pull-over location 615 to select, the computing system 600 (e.g., the local router 655) can include a pull-over ranker 640. The pull-over ranker 640 can be a system/module within the route planner 630. The pull-over ranker 640 can be configured to rank the candidate pull-over locations 615. The pull-over ranker 640 can determine a ranking 645 of the one or more candidate pull-over locations 615 based on at least one of: a quality of each respective candidate pull-over location 615, a feasibility of the autonomous vehicle 405 completing a stop at each respective candidate pull-over location 615, or a constraint associated with the pull-over command 605 (e.g., a target time or target distance).

The quality of a respective candidate pull-over location 615 can be indicative of the location's objective quality. The quality of a respective candidate pull-over location 615 can be based on a variety of factors.

The quality of a respective candidate pull-over location 615 can be based on the length and width of the candidate. For example, the quality can be higher for a respective candidate pull-over location 615 that has a length and width that more easily allows the entire autonomous vehicle 405 (e.g., tractor and trailer) to fit within the pull-over location 615. This allows the motion planner to more easily plan the motion of the autonomous vehicle 405 to stop within the bounds of the pull-over location with an offset distance from any lane markings, guardrails, etc. The quality can be lower in the event the respective candidate pull-over location 615 has a smaller length and width such that the entire autonomous vehicle 405 (e.g., tractor and trailer) narrowly fits within the pull-over location 615 (e.g., thereby requiring higher planning precision).

The quality of a respective candidate pull-over location 615 can be based on a clearance distance. The clearance distance can be indicative of an estimated distance between the autonomous vehicle 405 and the closest boundary (e.g., lane marking, physical barrier, etc.) or traffic lane when the autonomous vehicle 405 is stopped within the pull-over location. A higher clearance distance can contribute to a higher quality value.

The quality of a respective candidate pull-over location 615 can be based on a position of the candidate pull-over location 615 relative to a travel way. For instance, an off-ramp position may lend to a higher quality than a candidate pull-over location 615 on a left-hand shoulder within a median of the travel way.

The quality can be defined in terms of classes. This can include, for instance, five classes where the first class is indicative of the highest quality. A first class can include, for example, an off-ramp, wide shoulder (e.g., >3 m) that has at least some offset clearance from traffic and adequate length for the entire autonomous vehicle 405. The first class can also include a very wide shoulder (e.g., >6 m) with more substantial offset clearance (e.g., >2 m). A second class can include a wide shoulder that may not be off-ramp and may have a more limited clearance offset. A third class can include a preferred shoulder but that has very limited offset clearance. A fourth class can include a mapped shoulder that has a restricted boundary type that is generally not conducive to shouldering a vehicle and has a very limited offset. A fifth class may include a narrow shoulder with no offset clearance or possible traffic encroachments.

The feasibility associated with a candidate pull-over location 615 can be indicative of the likelihood of the autonomous vehicle 405 being able to physically travel to and stop at that location. For instance, the feasibility can represent a probability of the autonomous vehicle 405 being able to reach, and stop at, the pull-over location based on the vehicle's motion parameters and/or the target time (and/or target distance) for the autonomous vehicle 405 to pull-over. The motion parameters may include a speed of the autonomous vehicle 405, a heading of the autonomous vehicle 405, or a lane of the autonomous vehicle 405 within the travel way (e.g. the vehicle's current lane, the traffic/crowdedness of an adjacent lane, the opportunity/ability for the vehicle to change lanes). By way of example, if, given the current speed of the autonomous vehicle 405, navigating to a particular pull-over location would cause a high rate of jerk or lateral acceleration (e.g., due to swerving or braking), the feasibility may be lower than for a pull-over location that is further away where there would be less jerk motion.

The constraints associated with the pull-over command 605 can be indicative of a target time or target distance within which the autonomous vehicle 405 is to pull-over. As described herein, this may be set by the vehicle's on-board computing system or a remote computing system 500. The target time (or distance) may depend on the severity of the conditions associated with the pull-over command 605. The higher the severity, the less time or distance the autonomous vehicle 405 may have to perform the pull-over maneuver. The lower the severity, the more time or distance the autonomous vehicle 405 may have to pull-over. For example, the target time may indicate the autonomous vehicle 405 has 20 minutes to pull-over to a shoulder based on upcoming inclement weather. In another example, the target distance may indicate the autonomous vehicle 405 should pull-over to the shoulder within the next 2 km based on an approaching emergency vehicle.

The ranking of a particular pull-over location may depend on whether the autonomous vehicle 405 can obey a time or distance constraint in navigating to that pull-over location. For example, the ranking for a respective candidate pull-over location 615 may be higher if there is sufficient time for the autonomous vehicle 405 to travel to that candidate pull-over location given the time or distance constraint. On the other hand, the ranking for a respective candidate pull-over location 615 may be lower if the autonomous vehicle 405 cannot reach that candidate pull-over location within the time or distance constraint.

To properly weigh the various factors for ranking the candidate pull-over locations 615, the pull-over ranker 640 can utilize a cost analysis. This cost-based approach can be advantageous over a hierarchical-based approach because the hierarchical-based approach can make it difficult weigh the various factors against each other, does not handle well the possibility of no pull-over locations fulfilling the appropriate criteria, and does not take into account the probability of error or inaccuracies.

To perform the cost analysis, the pull-over ranker 640 can utilize a cost function. For each respective candidate pull-over location 615, the cost function can compute: (i) its quality score; (ii) its feasibility for the autonomous vehicle 405; and (ii) the ability for the autonomous vehicle 405 to pull-over within any time or distance constraints. The cost function can also evaluate whether there is an equivalent candidate pull-over location (e.g., with a similar cost) that would appear earlier in the route 620.

These features can be reflected as sub-costs for calculating a total cost (Costₚᵤₗₗₒᵥₑᵣ) for each respective candidate pull-over location 615. The following is an example cost function for a given candidate pull-over location:

$${Cost}_{pull over} = {QualityCost}_{pull over} * P ( success ) + {\sum }_{i}^{all following pods} {Cost}_{{i}^{th} pull over} * P ( {success}_{i} ) * P ( fail {}_{0 , i - 1} )$$

QualityCost_{pull over} represents the quality score of the given candidate pull-over location plus a distance along the route to the given candidate pull-over location, P(success) represents a probability of the autonomous vehicle 405 successfully making it to that given candidate pull-over location, and Σᵢ^{all following pods}Cost_{ith pull over}*P(successᵢ)*P(fail□_{o, i-1}) represents the quality costs and success probability of making it to the other candidate pull-over locations (also referred to as “pods”).

This cost function can be simplified to reduce computational complexity for the limited onboard computing resources of the autonomous vehicle 405. For example, an interpolation can be computed between quality cost and expected time remaining/distance remaining (for time or location faults respectively) once a pull-over is reached. Each feature can first be normalized to a 0-1 value, and then multiplied by a weight. This can result in the following cost function:

$${Cost}_{pull over} = {C}_{is feasible} + {C}_{distance along route} + {C}_{length of pod} + {QualityCost}_{pull over * {W}_{fault}}$$

where C_{feature}=v_{feature}*w_{feature}, v is the value of the feature and takes between 0 and 1, and w is the weight of the feature.

The pull-over ranker 640 can evaluate the value of the various features. For example, C_{is feasibility} can be 0 if the autonomous vehicle can stop by the end of the candidate pull-over location 615 given the allowed acceleration. The value for C_{distance along route} can be defined as Clamp (0, range start/max d, 1), which is a linear cost. The range start is the distance to the respective pull-over location along the route and max d is the longest distance between pull-over locations along a particular route 620 (e.g., 3×10⁶ m). The value for C_{length of pod} can be defined as Clamp (0, range length/max l, 1), where max l is the maximum length of the candidate pull-over locations 615 associated with a route 620. The value for QualityCostₚᵤₗₗₒᵥₑᵣ can be defined as pull-over priority class/n, where n is the number of priority classes utilized for characterizing quality. The costs functions described about are merely illustrative, and any appropriate combination of costs may be used to rank the pull-over locations.

The pull-over ranker 640 can assign various weights to the sub-costs of the cost function. In an example, weights can be assigned to ensure that only feasible pull-over locations are chosen, any feasible pull-over location is preferred over choosing no pull-over location at all, quality cost takes the highest priority, and range start is the first tie-breaker while the length of the pull-over location is second. The weights can be orders of magnitude different from one another (e.g., 101, 102, 104, 106, 108, etc.).

The ranking 645 can be computed based on the cost function. For example, the pull-over ranker 640 can compute the cost for each candidate pull-over location 615. The ranking 645 can include a list of the candidate pull-over locations 615 (or at least a portion thereof) in order of lowest cost to highest cost.

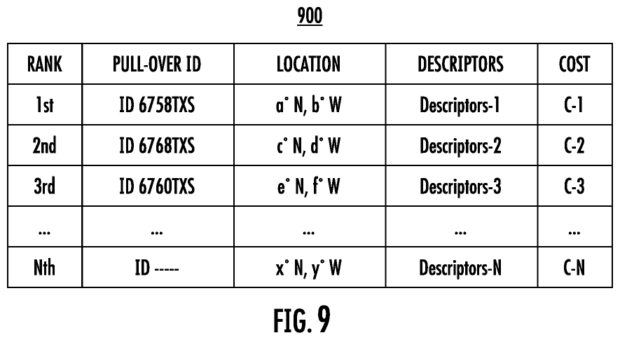

The ranking 645 can be expressed within a data structure. For example, FIG. 9 depicts an example data structure 900. The data structure 900 can be a table, list, etc. showing the candidate pull-over locations 615 in ranked order. The ranked order can be based on the cost associated with the respective candidate pull-over location 615, ordering the candidate pull-over locations 615 from lowest cost (C-1) to highest cost (C-N). Each respective candidate pull-over location 615 can be represented in the data structure 900 by one or more data entries. This can include the descriptors of the candidate pull-over locations, the location, an ID, etc.

Additionally, or alternatively, the rankings 645 can be indicative of the global route 620 appended with descriptors 710 for each candidate pull-over location 615 and the ranking 645 of the candidate pull-over locations 615.

The motion planner 650 can be, or be configured to perform similar functionality as, previously described planning system 250. For example, the motion planner 650 can plan the motion of the autonomous vehicle 405 to reach a pull-over location using the output from the route planner 630.

Based on the ranking 645 of the one or more candidate pull-over locations 615, the computing system 600 can determine a selected pull-over location 660 for the autonomous vehicle 405. The computing system 600 can control a motion of the autonomous vehicle 405 based on the selected pull-over location 660.

To help do so, the local router 655 can be configured to run functions similar to that of the route planner 630 over a routing graph built on a local region layout. The local router 655 can ingest inputs such as: the global route 620 (including its segment points), the descriptors 710 and ranking 645 appended to the global route 620 (e.g., as route data), data indicative of relevant regions, localization data (e.g., global pose, etc.), and/or other inputs.

The local router 655 can be configured to select a pull-over location from the ranked candidate pull-over locations 615. For example, the local router 655 can access data indicative of the ranking 645 and identify the lowest cost candidate pull-over location. The lowest cost candidate pull-over location can be the selected pull-over location 660.

The local router 655 can route the autonomous vehicle 405 to the selected pull-over location 660. To do so, the local router 655 can generate a pull-over route 665 for the autonomous vehicle 405 to travel to the selected pull-over location 660. The pull-over route 665 can be local route that routes the autonomous vehicle 405 to the selected pull-over location 660.

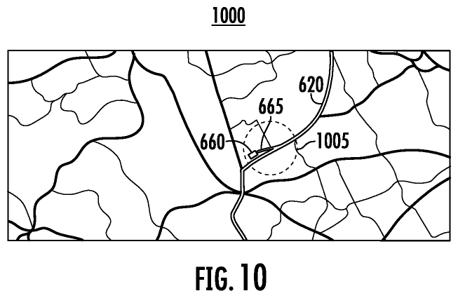

FIG. 10 is a diagram 1000 that depicts the global route 620, a local map layout 1005, the pull-over route 665, and the selected pull-over location 660.

To implement the pull-over route 665, the motion planner 650 can replace the global route 620 with a pull-over route 665. For instance, the motion planner 650 can continue to follow the global route 620 until the selected pull-over location 660 is within the local map layout 1005 (e.g., within 1000 m from the current location of autonomous vehicle 405). When the selected pull-over location 660 is within the local map layout 1005, the local router 655 can produce a pull-over route 665 for routing the autonomous vehicle 405 to the selected pull-over location 660.

By way of example, in the event the selected pull-over location 660 is within a shoulder of a road, the pull-over route 665 can plan a route to the lane adjacent to the shoulder (e.g., the rightmost lane) and mark the goal type within the motion planner 650 as “SHOULDER”. The motion planner 650 (e.g., the local router 655) can swap the global route 620 with the pull-over route 665 to the shoulder. To do so, the local router 655 can overwrite the planned segment points of the global route 620 received from the route planner 630 with the new segment points associated with the pull-over route 665. The motion planner 650 can also ensure that wicket streams created for directing the motion of the autonomous vehicle 405 place the vehicle's goal onto the shoulder. This can be accomplished by increasing the cost of the wickets associated with the lanes adjacent to the shoulder so that the autonomous vehicle 405 plans it motion to the shoulder, which is lower cost. The goal can be generated so that the autonomous vehicle 405 knows that it is to come to a stop at the goal. In the event that the goal (e.g., the shoulder) is unreachable (e.g., due to an unforeseen obstruction), the local router 655 can output a notification and return the motion planner 650 to the global route 620.

In some implementations, the selected pull-over location 660 and the pull-over route 665 is provided to a remote computing system 500 for selection by a user. For instance, a teleassist operator may review and confirm (e.g., via input to the user interface 520) that the autonomous vehicle 405 is to utilize the selected pull-over location 660 and the pull-over route 665. Once confirmed, the remote computing system 500 can transmit a confirmation to the autonomous vehicle 405. The autonomous vehicle 405 can travel along the pull-over route 665 to arrive nearby the selected pull-over location 660.

The motion planner 650 can control the motion of the autonomous vehicle in accordance with the pull-over route 665. For instance, upon replacement of the global route 620 with the pull-over route 665, the motion planner 650 can adjust the route of the autonomous vehicle 405 such that the autonomous vehicle 405 is routed to the selected pull-over location 660. The motion planner 650 can plan the motion of the autonomous vehicle 405 such that it travels in accordance with the segments of the pull-over route 665. In doing so, the autonomous vehicle 405 can change lanes or utilize an exit ramp to move the autonomous vehicle 405 toward the side of the travel way that includes the selected pull-over location 660.

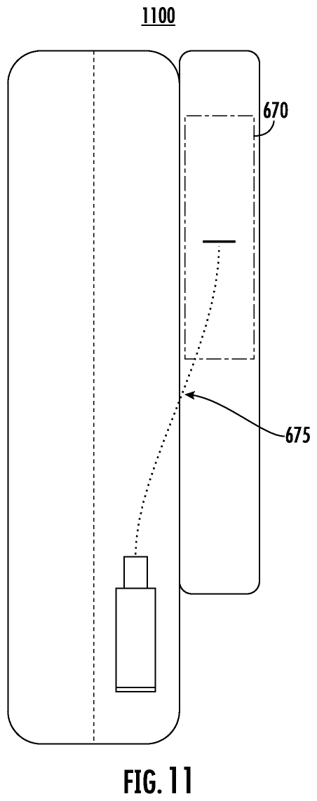

With reference to FIGS. 6 & 11, the selected pull-over location 660 can include a goal range 670. The goal range 670 can define, in a manner ingestible by the motion planner 650, an area associated with the selected pull-over location 660 in which the autonomous vehicle 405 is to stop. The goal range 670 can be based on the dimensions of the selected pull-over location 660. The goal range 670 can define, for example, an area (e.g., a rectangular area), on a shoulder of a travel way, in which the autonomous vehicle 405 is to stop. The goal range 670 for the selected pull-over location 660 can be encoded within the route data that includes the pull-over route 665. FIG. 11 presents a diagram 1100 of the goal range 670 associated with the selected pull-over location 660.

The motion planner 650 can generate a trajectory 675 for the autonomous vehicle 405 to travel to a stopped position within the goal range 670 associated with the selected pull-over location 660. The trajectory 675 can include a plurality of way points that more granularly guide the autonomous vehicle 405 into a stopped position within the goal range 670 of the selected pull-over location 660, than would be accomplished by the pull-over route 665 alone. The autonomous vehicle 405 can control its motion based on the trajectory 675 (e.g., using the platform control devices 212) such that the autonomous vehicle 405 reaches the stopped position within the goal range 670. By doing so, the autonomous vehicle 405 can ensure that it is properly positioned at the selected pull-over location 660, with the threshold margins from the lane boundaries.

With reference again to FIG. 5, to help monitor the operations of the autonomous vehicle 405, the remote computing system 500 can include a display device 515 configured to present a user interface 520. For instance, autonomous vehicle 405 can transmit a message 510 to the remote computing system 500. The message 510 can indicate the selected pull-over location 660, the pull-over route 665, the trajectory 675, or other information from the motion planner 650. The display device 515 can utilize this information to render an animation or other type of graphic to reflect the operations and movement of the autonomous vehicle 405 via the user interface 520. The user interface 520 can depict the selected pull-over location 660, the pull-over route 665, the trajectory 675, or other information.

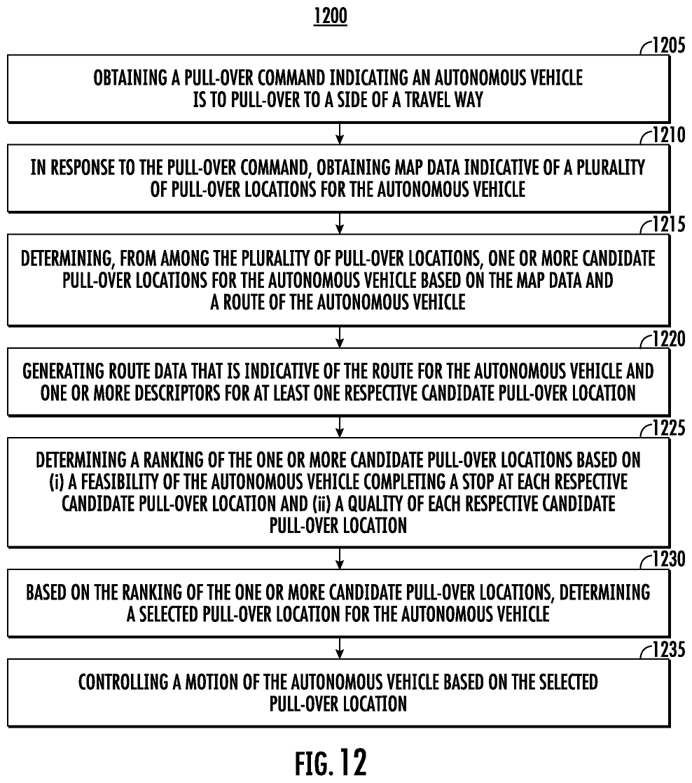

FIGS. 12-15 are flowcharts of example methods 1200-1500 for autonomous vehicle pull-over control, according to some implementations of the present disclosure. One or more portions of the methods 1200-1500 can be implemented by a computing system that includes one or more computing devices such as, for example, the computing systems described with reference to the other figures (e.g., autonomous platform 110, vehicle computing system 180, remote system(s) 160, a system described with reference to FIGS. 4-11, etc.). Each respective portion of methods 1200-1500 can be performed by any (or any combination) of one or more computing devices. Moreover, one or more portion(s) of methods 1200-1500 can be implemented on the hardware components of the device(s) described herein, for example, to select, plan, and control an autonomous vehicle to pull-over.

FIGS. 12-15 depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIGS. 12-15 are described with reference to elements/terms described with respect to other systems and figures for exemplary illustrated purposes and is not meant to be limiting. One or more portions of methods 1200-1500 can be performed additionally, or alternatively, by other systems.

With reference to FIG. 12, at 1205, example method 1200 can include obtaining a pull-over command indicating an autonomous vehicle is to pull-over to a side of a travel way (e.g., a road). The pull-over command can be obtained by the autonomous vehicle in that it can be generated by a system onboard the autonomous vehicle or received from a system that is offboard the autonomous vehicle. For instance, a computing system of the autonomous vehicle can generate the pull-over command in response to at least one of: (i) a software fault of the autonomous vehicle; (ii) a hardware fault of the autonomous vehicle, (iii) a detected environmental condition, or (iv) a collision (e.g., involving the vehicle, involving other objects). The detected environmental condition can include inclement weather, travel way blockages, an emergency vehicle, etc.

Additionally, or alternatively, the pull-over command can be obtained from a remote computing system that is remote from the autonomous vehicle. This can include, for example, a remote assistance system. The remote computing system can determine that one or more conditions exist in which it would be preferable for the autonomous vehicle to pull-over. This determination can be based on data provided by the autonomous vehicle, sensor data, data from a third party service (e.g., weather service, traffic service), etc. The conditions can be similar to those detectable by the onboard computing system.

In some implementations, the pull-over command is generated by the remote computing system based on user input from a human operator that has determined it is preferable for the autonomous vehicle to pull-over. For example, the human operator may review weather radar data and determine that the autonomous vehicle should pull over due to an upcoming hailstorm.

The pull-over command can include various information in its data payload. For example, the pull-over command can include a time constraint or a distance constraint for the autonomous vehicle to obey the pull-over command. The time constraint can indicate a target time for the autonomous vehicle to pull-over. The target time can be expressed in terms of an amount of time (e.g., within the next 5, 10, 20, 30 minutes) or a time of day (e.g., by 1:29 pm CT). The distance constraint can indicate a target distance or location by which the autonomous vehicle is to pull-over. The target distance can be expressed in terms of a numerical distance (e.g., within the next 2, 5, 10, 20 km) or as a particular location (e.g., by a certain exit, mile marker, address, lat./long. coordinate set). The target time and/or target distance for the autonomous vehicle can be provided by a remote computing system that is remote from the autonomous vehicle.

In response to the pull-over command, at 1210, example method 1200 can include obtaining map data indicative of a plurality of pull-over locations for the autonomous vehicle. For instance, the computing system of the autonomous vehicle can access map data of the geographic area in which the autonomous vehicle is travelling. As described herein, the map data can be encoded with descriptors for a plurality of pull-over locations that have been identified within the geographic area. This can include, for example, pull-over locations that have been identified within a portion of a state in which the autonomous vehicle is travelling from City A to City B. The descriptors can provide information about a respective pull-over location including its dimensions (e.g., width, length), speed constraints, location, position relative to the road, etc.

At 1215, example method 1200 can include determining, from among the plurality of pull-over locations, one or more candidate pull-over locations for the autonomous vehicle based on the map data and a route of the autonomous vehicle. To do so, the computing system can determine a distance from the autonomous vehicle (e.g., along its current route) to each of the plurality of pull-over locations and determine the one or more candidate pull-over locations based on the distance from the autonomous vehicle to each of the plurality of pull-over locations.

In an example, the route of the autonomous vehicle can be the global route the autonomous vehicle is currently following from City A to City B and can contain mostly highway travel. The autonomous vehicle may be halfway between City A to City B when it receives the pull-over command (e.g., due to the upcoming hailstorm). As described herein, a computing system can determine the candidate pull-over locations by filtering out the plurality of pull-over locations that are behind the autonomous vehicle. This can include filtering out the pull-over locations that are along the portion of the global route from City A to City B that has already been traversed by the autonomous vehicle.

Additionally, or alternatively, the candidate pull-over locations can be those that are within a threshold distance or travel time from the global route. The threshold distance or travel time can be calculated based on the state of the autonomous vehicle. For instance, the computing system can filter out pull-over locations that are beyond a distance that the autonomous vehicle could travel to based on its current fuel or charge level.

At 1220, example method 1200 can include generating route data that is indicative of the route for the autonomous vehicle and one or more descriptors for at least one respective candidate pull-over location. For instance, the computing system can generate such route data by appending the data indicative of the candidate pull-over locations and their descriptors to data indicative of the global route (e.g., from City A to City B).

At 1225, example method 1200 can include determining a ranking of the one or more candidate pull-over locations based on (i) a feasibility of the autonomous vehicle completing a stop at each respective candidate pull-over location and (ii) a quality of each respective candidate pull-over location. Additionally, or alternatively, the ranking can be based on the time or distance constraints for the autonomous vehicle to pull-over.

The computing system can determine the ranking of the one or more candidate pull-over locations based on one or more motion parameters of the autonomous vehicle and a target time (or distance) for the autonomous vehicle to pull-over. This can be reflected as the feasibility of a given candidate pull-over location. For example, as described herein, the feasibility of the autonomous vehicle completing the stop at each respective pull-over location can be indicative of a probability of the autonomous vehicle being able to travel to a stopped position at the pull-over location based on the motion parameter(s) and within the target time (or distance) for the autonomous vehicle to pull-over. The motion parameter(s) can be indicative of at least one of: (i) a speed of the autonomous vehicle, (ii) a heading of the autonomous vehicle, or (iii) a lane of the autonomous vehicle. As described, the feasibility can indicate whether adjusting the motion of the autonomous vehicle to stop at a given candidate pull-over location, within the target time/distance for doing so, would cause swerving, high levels of jerk, etc. based on the vehicle's current motion or position.

The quality of the respective candidate pull-over location can be based on a width and a length of the respective candidate shoulder location. For example, the greater the width and length, the larger the area for stopping the autonomous vehicle. This allows for a greater likelihood that the autonomous vehicle will have substantial clearance from lane markings or other boundaries, and easier motion planning.

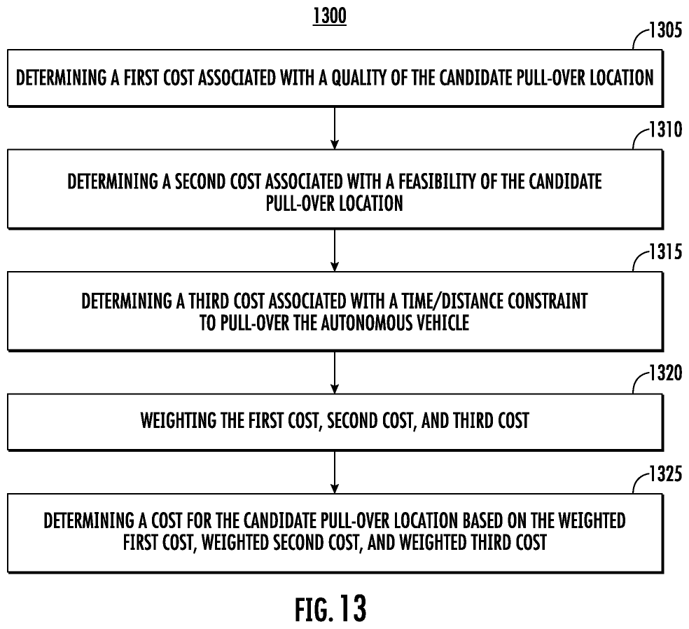

As described herein, the ranking of candidate pull-over locations can be computed based on a cost function that provides a cost for stopping at a particular candidate pull-over location. The cost function can include sub-costs that reflect various factors. Example method 1300 of FIG. 13 can be used for costing the candidate pull-over locations.

At 1305, example method 1300 can include determining a first cost associated with a quality of the candidate pull-over location (a “quality cost”). The quality cost can be based on a position of the pull-over location relative to the travel way, the dimensions of the pull-over location, the distance of clearance the autonomous vehicle will have in the candidate pull-over location (e.g., from traffic lanes), or other factors. For example, candidate pull-over locations that are wider and positioned on off-ramps or shoulders with substantial clearance, can have a lower quality cost.

At 1310, example method 1300 can include determining a second cost associated with a feasibility of the candidate pull-over location (a “feasibility cost”). As described herein, the feasibility cost can be higher in the event that reaching the candidate pull-over location would result in substantial jerk, swerving, rapid lane changes, etc. The feasibility cost can be lower in the event that reaching the candidate pull-over location would result in less sudden lateral acceleration, gradual lane changes, etc.

At 1315, example method 1300 can include determining a third cost associated with a time/distance constraint to pull-over the autonomous vehicle (a “constraint cost”). The constraint cost can be higher in the event that it is unlikely that the autonomous vehicle would be able to reach the candidate pull-over location within the target time/distance (e.g., within the next 10 minutes before the hailstorm is estimated to start). The constraint cost can be lower in the event that the autonomous vehicle would easily be able to reach the candidate pull-over location within the target time/distance.

As described herein, the cost function can include additional sub-costs related to the candidate pull-over locations. For example, a candidate pull-over location with overhead coverage (e.g., under an overpass out of the hailstorm) may have a lower cost than one without overhead coverage.

At 1320, example method 1300 can include weighting the first cost, second cost, third cost, and/or any other costs. The cost function can assign different weights to each of these costs in order to prioritize certain cost factors over others. In an example, the quality cost and feasibility cost may be weighted higher than the constraint cost in the event the target time/distance is conservatively based on the estimated time that a hailstorm will start (and, thus, the autonomous vehicle may have additional time to pull-over).

At 1325, example method 1300 can include determining a cost for the candidate pull-over location based on the weighted first cost, weighted second cost, weighted third cost, and/or any other weighted costs. For instance, the computing system can utilize the cost function to aggregate these weighted costs to determine a total cost for each respective candidate pull-over location. The ranking of the candidate pull-over locations can rank the candidates from lowest cost to highest cost.

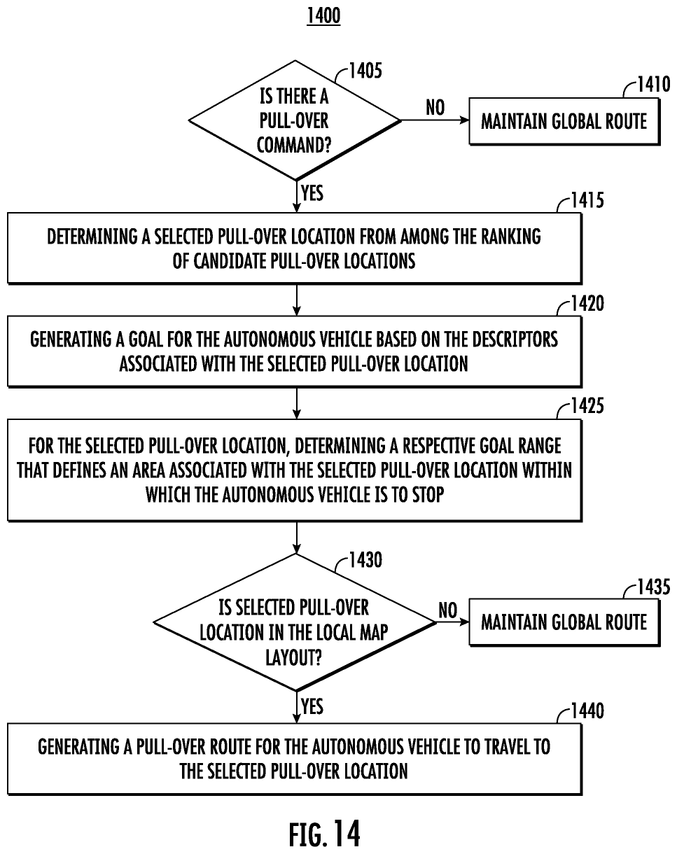

Returning to FIG. 12, at 1230 and 1235, example method 1200 can include, based on the ranking of the one or more candidate pull-over locations, determining a selected pull-over location for the autonomous vehicle and controlling a motion of the autonomous vehicle based on the selected pull-over location. Method 1400 of FIG. 14 provides example operations that a computing system (e.g., its motion planner) may implement to perform such functions.

At 1405, example method 1400 can include determining whether there is an active pull-over command. If not, at 1410, the computing system can continue to implement the global route of the autonomous vehicle.

If there is an active pull-over command, at 1415, example method 1400 can include determining a selected pull-over location from among the ranking of candidate pull-over locations. As described herein, the computing system can select the candidate pull-location with the lowest cost. This may include, for example, an area on the shoulder of a road that is a wide (and long) for the entire autonomous vehicle (e.g., tractor and trailer), provides substantial clearance from an adjacent lane or any physical barriers, and is located such that the autonomous vehicle can stop there within a target time (e.g., before the hailstorm may start).

At 1420, example method 1400 can include generating a goal for the autonomous vehicle based on the descriptors associated with the selected pull-over location. As described herein, for goal-based routing and motion planning, the computing system can set a goal for the autonomous vehicle to reach the selected pull-over location on the shoulder.

At 1425, example method 1400 can include, for the selected pull-over location, determining a respective goal range that defines an area associated with the selected pull-over location within which the autonomous vehicle is to stop. This goal range can be set so that the entire autonomous vehicle (e.g., tractor and trailer) are within the bounds of the selected pull-over location on the shoulder, with clearance from the adjacent lane.

At 1430, example method 1400 can include determining whether the selected pull-over location is within the local map layout. This can include using a location descriptor (e.g., lat./long. coordinate) associated with the selected pull-over location to determine if the selected pull-over location is within a 1000 m, 2000 m, 5000 m, etc. map area/tile currently used by the motion planner. If not, the autonomous vehicle 405 can continue to implement the global route.

When the selected pull-location is within the local map layout, at 1440, example method 1400 can include generating a pull-over route for the autonomous vehicle to travel to the selected pull-over location. As described herein, the pull-over route can include at least some different segments from the global route such that the autonomous vehicle is routed to the pull-over location, rather than to City B. Local routing can include changing lanes to the lane adjacent to the shoulder containing the selected pull-over location and routing the vehicle such that it arrives nearby.

In some implementations, the pull-over route is generated prior to the selected candidate pull-over location being in the local map layout. Once the selected candidate pull-over location is determined to be within the local map layout or within some threshold distance/time from the autonomous vehicle (e.g., 1000 km, 36 seconds), the computing system can access and implement the pull-over route.

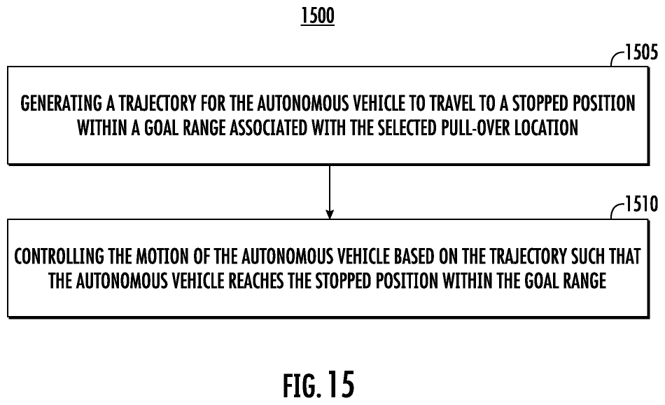

As the autonomous vehicle approaches the selected pull-over location using the pull-over route, the computing can utilize the more fine-grained motion planning trajectories to stop the autonomous vehicle in the desired position. For example, with reference to FIG. 15, at 1505, example method 1500 can include generating a trajectory for the autonomous vehicle to travel to a stopped position within a goal range associated with the selected pull-over location. The trajectory can include a series of waypoints and motion control parameters (e.g., braking/steering instructions) to position the entire autonomous vehicle within the goal range in a stopped position.

At 1510, example method 1500 can include controlling the motion of the autonomous vehicle based on the trajectory such that the autonomous vehicle reaches the stopped position within the goal range. This can include, for example, providing signals to the control devices of the autonomous vehicle (or an interface thereof) to control the vehicle's motion in accordance with the trajectory.

In this way, the technology of the present disclosure can leverage the vehicle's route planning capability to intelligently rank and select pull-over locations, while empowering the vehicle's motion planner to craft precise pull-over route plans within the local map layout that accurately lead to a stop at the selected pull-over location.

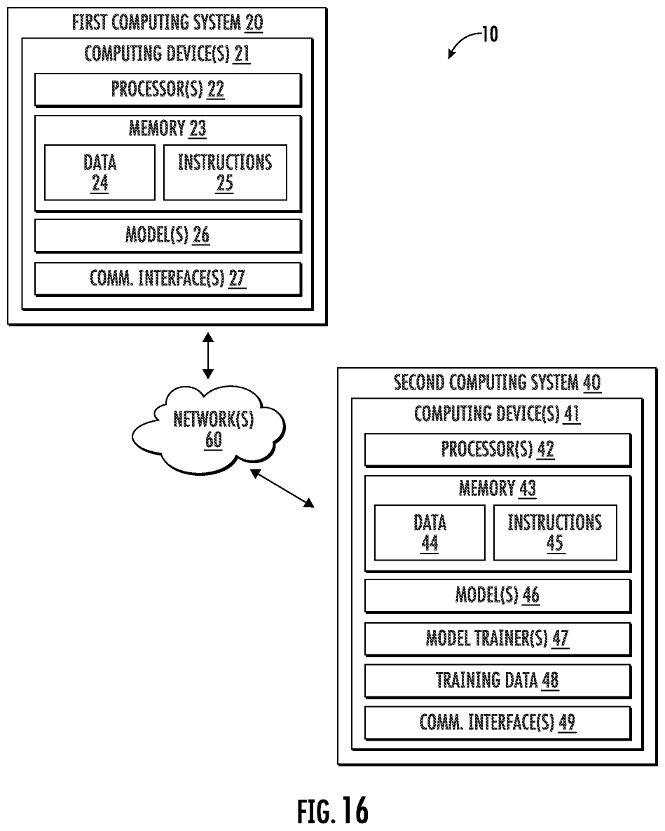

FIG. 16 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein for selecting a pull-over location for the autonomous vehicle and planning/controlling its motion accordingly.

In some implementations, the first computing system 20 can be included in an autonomous platform and be utilized to perform the functions of an autonomous platform (e.g., autonomous vehicle) as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, computing system 600, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. Memory 23 can include one or more non-transitory computer-readable storage media, such as RAM, ROM, EEPROM, EPROM, one or more memory devices, flash memory devices, etc., and combinations thereof.

Memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data (e.g., encoded with pull-over locations), data associated with autonomy functions (e.g., data associated with the perception, planning, or control functions), simulation data, pull-over commands, data indicative of conditions for pulling over, pull-over routes, selected pull-over locations, timing/distance constraints, or any data or information described herein. In some implementations, the first computing system 20 can obtain data from one or more memory device(s) that are remote from the first computing system 20.

Memory 23 can store computer-readable instructions 25 that can be executed by the one or more processors 22. Instructions 25 can be software written in any suitable programming language or can be implemented in hardware. Additionally, or alternatively, instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include implementing system validation (e.g., as described herein).

In some implementations, the first computing system 20 can store or include one or more models 26. In some implementations, the models 26 can be or can otherwise include one or more machine-learned models (e.g., a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system(s) 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, etc. In some implementations, one or more models can be trained to perform the functions described herein for determining that an autonomous vehicle should pull-over, determining candidate pull-over locations, generating route data appended with descriptors, ranking candidate pull-over locations, selecting candidate pull-over locations, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

Memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data (e.g., encoded with pull-over locations), simulation data, simulated environmental scenes, simulated sensor data, data associated with vehicle trips/services, data indicative of conditions for pulling over, pull-over routes, selected pull-over locations, timing/distance constraints, pull-over commands, or any data or information described herein. In some implementations, the second computing system 40 can obtain data from one or more memory device(s) that are remote from the second computing system 40.

Memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system(s) 200 (e.g., localization, perception, planning, control, etc.) or other functionality associated with an autonomous platform (e.g., remote assistance, mapping, fleet management, trip/service assignment and matching, etc.). This can also include, for example, identifying that an autonomous vehicle should pull-over, determining candidate pull-over locations, ranking candidate pull-over locations, selecting a pull-over location, generating a pull-over route, providing instructions to an autonomous vehicle to pull-over, or any other operations/functions described herein.

In some implementations, second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system(s) 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system(s) 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 17 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, comprising:
(a) obtaining a pull-over command indicating an autonomous vehicle is to pull-over to a side of a travel way;
(b) in response to the pull-over command, obtaining map data indicative of a plurality of pull-over locations for the autonomous vehicle;
(c) determining, from among the plurality of pull-over locations, one or more candidate pull-over locations for the autonomous vehicle based on the map data and a route of the autonomous vehicle;
(d) determining a ranking of the one or more candidate pull-over locations based on (i) a feasibility of the autonomous vehicle completing a stop at each respective candidate pull-over location and (ii) a quality of each respective candidate pull-over location;
(e) based on the ranking of the one or more candidate pull-over locations, determining a selected pull-over location for the autonomous vehicle; and
(f) controlling a motion of the autonomous vehicle based on the selected pull-over location.

2. The computer-implemented method of claim 1, further comprising:
(g) for the selected pull-over location, determining a respective goal range that defines an area associated with the selected pull-over location within which the autonomous vehicle is to stop.

3. The computer-implemented method of claim 1, wherein (f) comprises:
generating a trajectory for the autonomous vehicle to travel to a stopped position within a goal range associated with the selected pull-over location; and
controlling the motion of the autonomous vehicle based on the trajectory such that the autonomous vehicle reaches the stopped position within the goal range.

4. The computer-implemented method of claim 1, wherein (d) comprises determining the ranking of the one or more candidate pull-over locations based on one or more motion parameters of the autonomous vehicle and a target time for the autonomous vehicle to pull-over.

5. The computer-implemented method of claim 4, wherein the feasibility of the autonomous vehicle completing the stop at each respective pull-over location is indicative of a probability of the autonomous vehicle being able to travel to a stopped position at the pull-over location based on the one or more motion parameters and within the target time for the autonomous vehicle to pull-over.

6. The computer-implemented method of claim 4, wherein the one or more motion parameters are indicative of at least one of: (i) a speed of the autonomous vehicle, (ii) a heading of the autonomous vehicle, or (iii) a lane of the autonomous vehicle.

7. The computer-implemented method of claim 4, wherein the target time for the autonomous vehicle to pull-over is provided by a remote computing system that is remote from the autonomous vehicle.

8. The computer-implemented method of claim 1, wherein (c) comprises:
determining a distance from the autonomous vehicle to each of the plurality of pull-over locations; and
determining the one or more candidate pull-over locations based on the distance from the autonomous vehicle to each of the plurality of pull-over locations.

9. The computer-implemented method of claim 1, wherein the quality of the respective candidate pull-over location is based on a width and a length of a respective candidate pull-over location.

10. The computer-implemented method of claim 1, wherein the pull-over command is obtained from a remote computing system that is remote from the autonomous vehicle or is generated by a computing system onboard the autonomous vehicle, and wherein the pull-over command is generated in response to at least one of: (i) a software fault of the autonomous vehicle, (ii) a hardware fault of the autonomous vehicle, (iii) a detected environmental condition, or (iv) a collision.

11. The computer-implemented method of claim 1, further comprising:
(h) generating route data that is indicative of the route for the autonomous vehicle and one or more descriptors for at least one respective candidate pull-over location.

12. An autonomous vehicle control system comprising:
one or more processors; and
one or more tangible non-transitory computer-readable media storing instruction that are executable by the one or more processors to perform operations, the operations comprising:
(a) obtaining a pull-over command indicating an autonomous vehicle is to pull-over to a side of a travel way;
(b) in response to the pull-over command, obtaining map data indicative of a plurality of pull-over locations for the autonomous vehicle;
(c) determining, from among the plurality of pull-over locations, one or more candidate pull-over locations for the autonomous vehicle based on the map data and a route of the autonomous vehicle;
(d) determining a ranking of the one or more candidate pull-over locations based on (i) a feasibility of the autonomous vehicle completing a stop at each respective candidate pull-over location and (ii) a quality of each respective candidate pull-over location;
(e) based on the ranking of the one or more candidate pull-over locations, determining a selected pull-over location for the autonomous vehicle; and
(f) controlling a motion of the autonomous vehicle based on the selected pull-over location.

13. The autonomous vehicle control system of claim 12, wherein the selected pull-over location comprises a goal range, and wherein (f) comprises:
generating a trajectory for the autonomous vehicle to travel to a stopped position within the goal range associated with the selected pull-over location; and
controlling the motion of the autonomous vehicle based on the trajectory such that the autonomous vehicle reaches the stopped position within the goal range.

14. The autonomous vehicle control system of claim 13, wherein the goal range defines an area, on a shoulder of the travel way, in which the autonomous vehicle is to stop.

15. The autonomous vehicle control system of claim 12, wherein (d) comprises determining a rank of a respective candidate pull-over location based on one or more motion parameters of the autonomous vehicle and a respective distance for the autonomous vehicle to reach the respective candidate pull-over location.

16. The autonomous vehicle control system of claim 12, wherein the plurality of pull-over locations are outside of a boundary defining one or more lanes of travel on the travel way.

17. The autonomous vehicle control system of claim 12, wherein (d) comprises performing a cost analysis of the one or more candidate pull-over locations, wherein a cost for a respective candidate pull-over location is based on the feasibility of the autonomous vehicle completing the stop at the respective pull-over location, the quality of the respective candidate pull-over location, and a timing or distance constraint for the autonomous vehicle to pull-over.

18. The autonomous vehicle control system of claim 12, wherein the operations further comprise:
generating a pull-over route for the autonomous vehicle to travel to the selected pull-over location, and wherein (f) comprises controlling the motion of the autonomous vehicle in accordance with the pull-over route.

19. An autonomous vehicle comprising:
one or more processors; and
one or more tangible non-transitory computer-readable media storing instructions that are executable by the one or more processors to perform operations, the operations comprising:
(a) obtaining a pull-over command indicating the autonomous vehicle is to pull-over to a side of a travel way;
(b) in response to the pull-over command, obtaining map data indicative of a plurality of pull-over locations for the autonomous vehicle;
(c) determining, from among the plurality of pull-over locations, one or more candidate pull-over locations for the autonomous vehicle based on the map data and a route of the autonomous vehicle;
(d) determining a ranking of the one or more candidate pull-over locations based on (i) a feasibility of the autonomous vehicle completing a stop at each respective candidate pull-over location and (ii) a quality of each respective candidate pull-over location;
(e) based on the ranking of the one or more candidate pull-over locations, determining a selected pull-over location for the autonomous vehicle; and
(f) controlling a motion of the autonomous vehicle based on the selected pull-over location.

20. The autonomous vehicle of claim 19, wherein the operations further comprise:
(g) adjusting the route of the autonomous vehicle such that the autonomous vehicle is routed to the selected pull-over location;
and wherein (f) comprises:
generating a trajectory for the autonomous vehicle to travel to a stopped position within a goal range associated with the selected pull-over location, and
controlling the motion of the autonomous vehicle based on the trajectory such that the autonomous vehicle reaches the stopped position within the goal range.
